(19) United States
(12) Patent Application Publication
(10) Pub. No.: US 2023/0348656 A1
(43) Pub. Date: Nov. 2, 2023

(54) INDUCTION HEATING-CURED ADHESIVES

(71) Applicant: NANYANG TECHNOLOGICAL UNIVERSITY, Singapore (SG)

(72) Inventors: Terry W.J. STEELE, Singapore (SG); Raju V. RAMANUJAN, Singapore (SG); Richa CHAUDHARY, Singapore (SG)

(21) Appl. No.: 18/041,385

(22) PCT Filed: Aug. 20, 2021
(86) PCT No.: PCT/SG2021/050490

§ 371 Date: Feb. 10, 2023

(30) Foreign Application Priority Data
Aug. 21, 2020 (SG) 10202008040V

(51) Int. Cl. C08G 59/40; C09J 9/00; C09J 11/04; C08K 3/22; C08K 5/09

(52) U.S. Cl. CPC C08G 59/4007; C09J 9/00; C09J 11/04; C08K 3/22; C08K 5/09; C08K 2003/2296; C08K 2003/2272; C08K 2003/2262

(57) ABSTRACT

Herein disclosed is an adhesive additive for magnetically curing an adhesive. The adhesive additive includes a magnetic nanoparticle that includes (i) a metal, wherein the metal comprises iron, manganese, cobalt, nickel, and/or zinc, or (ii) a metal oxide, wherein the metal oxide contains a metal which includes iron, manganese, cobalt, nickel, and/or zinc, a coating on the magnetic nanoparticle, wherein the coating comprises (a) a surfactant or an inorganic material, and (b) a monomer or a polymer which is miscible with an adhesive substrate which the adhesive additive is incorporable to, wherein the magnetic nanoparticle produces thermal energy in response to an alternating magnetic field applied thereto for the adhesive substrate to form cross-linkages. An adhesive, which is magnetically curable, is also disclosed herein. The adhesive includes the adhesive additive and an adhesive substrate. Methods of forming the adhesive additive are further disclosed herein.

### CROSS-REFERENCE TO RELATED APPLICATION

This application claims the benefit of priority of Singapore Patent Application No. 10202008040V, filed 21 Aug. 2020, the content of it being hereby incorporated by reference in its entirety for all purposes.

### TECHNICAL FIELD

The present disclosure relates to an adhesive additive for magnetically curing an adhesive. The present disclosure also relates to an adhesive which is magnetically curable and a method of forming the adhesive additive.

### BACKGROUND

For various applications, chemical curing adhesives (CCAs) may be preferred over mechanical fixation due to their lightweight, stress distributed bonding that does not damage a surface or material. The global market of instant curing adhesives is expected to be more than $3 billion USD, which may be dominated by two-part, thermosetting structural adhesives. Structural adhesives may require mixing of epoxy/hardener resins or thermal activation of one-pot epoxy/hardener blends (thermocuring), which leads to energy losses and stress/strain mismatches due to non-uniform temperature cycling of the materials and resin. Attempts to overcome these impediments may have led to alternative methods such as snap-cure epoxy, photocuring, electron beam curing, and emerging electrocuring.

Snap-cure thermosets tend to be one-pot adhesives that rapidly cure within minutes. However, the rapid curing nature is of limited benefit to insulating or heat-sensitive materials (e.g. wood, ceramics, or plastics).

Photocuring offers non-contact activation, but tends to depend on ultraviolet (UV) transparent materials and free radical initiators, which contribute to manufacturing problems of thermal sensitivity.

Electron beam curing may rely on the incoming high speed electrons that initiate free radicals within the polymer-initiator. The high energy of the electron beam/radiation offers uniform curing, but requires high capital and infrastructure investments. All parts must be electron irradiated, which require shielded rooms and advanced technically trained personnel.

Surface-curing adhesive tends to be composed of methyl/ethyl-cyanoacrylate, also known as ‘Superglue’. It may have the unique property of either forming strong surface bonds, or no bonding at all. The inability to bond rough/acidic surfaces (metals), difficulty in handling, brittle material properties, and low temperature durability (cured bonds must be kept less than 70° C.) limits surface-curing to do-it-yourself home repairs.

Formerly, few studies were initiated to develop alternating magnetic field (AMF) mediated adhesive curing (‘magnetocuring’), which may involve having thermoset adhesives in situ activated. Magnetocuring offers a non-contact method of bonding non-metal materials. Examples of such studies include magnetocuring based on FeCo epoxy composites, induction curing of thiol-acrylate and thiol-ene composites using cobalt and nickel particles, and polymerization of cyanate ester using Fe₃O₄ as an internal heat source through induction heating. Induction curing was also studied with nickel nanoparticles for bonding of composite as well as polymerizations using iron oxide nanochains. However, these formulations tend to have inherent detriments that limits industrial practice, such as but not limited to, (i) no surface functionalization of magnetocuring additives leading to poor colloidal stability, which prevents adequate shelf stability due to the formation of large aggregates, (ii) nanoparticle aggregates leading to undesirable heterogenous resins, which causes thermal hotspots and localized resin/epoxy pyrolysis, (iii) high heating powers (3-32 kW) paired with inefficient metallic Co (2 μm) and Ni (3 μm) particles or Fe₃O₄ particles, and (iv) use of high frequencies (more than 2 MHz) and Ni particles of broad particle size distribution (70 nm-22 μm) are impractical for commercial applications.

In another example, prior studies employed metallic/uncoated magnetic nanoparticles, which result in the aggregation of the nanoparticles and hotspot formation within the adhesive. To overcome these issues, colloidal stability of magnetic nanoparticles was studied with silica coating onto nanoparticles, but the silica-coated particles do not allow its inclusion in various resins. Application-oriented coating requires a different approach for each application. Further, most of the methods associated with the severe reaction conditions (high frequency and high magnetic field) resulted in the requirement of specially designed systems, which led to high capital costs of facility, limiting their commercial feasiblity. For example, high frequencies cannot penetrate deep into thick workpieces while low frequencies are preferred.

Adhesive curing via induction heating tends to be industrially applicable if colloidal stability of magnetic nanoparticles can be appropriately maintained, preventing aggregation-induced hotspots.

There is thus a need to provide for a solution that addresses one or more of the limitations mentioned above. The solution should at least provide for an improved and environmentally friendly adhesive composite.

### SUMMARY

In a first aspect, there is provided an adhesive additive for magnetically curing an adhesive, the adhesive additive includes:
a magnetic nanoparticle including
   (i) a metal, wherein the metal includes iron, manganese, cobalt, nickel, and/or zinc, or
   (ii) a metal oxide, wherein the metal oxide contains a metal which includes iron, manganese, cobalt, nickel, and/or zinc;
a coating on the magnetic nanoparticle, wherein the coating includes
   (a) a surfactant or an inorganic material; and
   (b) a monomer or a polymer which is miscible with an adhesive substrate which the adhesive additive is incorporable to,
wherein the magnetic nanoparticle produces thermal energy in response to an alternating magnetic field applied thereto for the adhesive substrate to form cross-linkages.

In another aspect, there is provided an adhesive which is magnetically curable, the adhesive includes:
the adhesive additive described in various embodiments of the first aspect; and
an adhesive substrate.

In another aspect, there is provided a method of forming the adhesive additive described in various embodiments of the first aspect, the method includes:
providing a magnetic nanoparticle including
   (i) a metal, wherein the metal includes iron, manganese, cobalt, nickel, and/or zinc, or
   (ii) a metal oxide, wherein the metal oxide contains a metal which includes iron, manganese, cobalt, nickel, and/or zinc;
mixing an aqueous solution including the magnetic nanoparticle with a surfactant; and
mixing an organic solution including the magnetic nanoparticle coated with the surfactant with (i) a monomer or (ii) a polymer which is miscible with an adhesive substrate which the adhesive additive is incorporable to.

In another aspect, there is provided a method of forming the adhesive additive described in various embodiments of the first aspect, the method includes:
providing a magnetic nanoparticle including
   (i) a metal, wherein the metal includes iron, manganese, cobalt, nickel, and/or zinc, or
   (ii) a metal oxide, wherein the metal oxide contains a metal which includes iron, manganese, cobalt, nickel, and/or zinc;
forming one or more surfactants on the magnetic nanoparticle;
forming an inorganic precursor on the one or more surfactants;
calcinating the magnetic nanoparticle with the inorganic precursor to remove the one or more surfactants and to form an inorganic material coated on the magnetic nanoparticle; and
mixing an organic mixture including the magnetic nanoparticle coated with the inorganic material with (i) a monomer or (ii) a polymer which is miscible with an adhesive substrate which the adhesive additive is incorporable to.

### BRIEF DESCRIPTION OF THE DRAWINGS

The drawings are not necessarily to scale, emphasis instead generally being placed upon illustrating the principles of the present disclosure. In the following description, various embodiments of the present disclosure are described with reference to the following drawings, in which:

FIG. 1A shows the X-ray powder diffraction (XRD) plot for the spinel phase formation of Mn_{0.4}Zn_{0.6}Fe₂O₄ to Mn_{0.7}Zn_{0.3}Fe₂O₄.

FIG. 1B is a plot of the Scherrer equation estimated crystalline size of Curie nanoparticles (CNPs) of FIG. 1A.

FIG. 1C shows the actual composition of CNPs of FIG. 1A measured by inductively coupled plasma mass spectrometry (ICP-MS) with standard deviation (SD) of <1% for Mn/Zn 50/50 and 70/30.

FIG. 1D is a plot of magnetic hysteresis loops measured at room temperature (about 27° C.) using physical property measurement system (PPMS) for the CNPs of FIG. 1A.

FIG. 1E is a plot of normalized magnetization as a function of temperature for the CNPs of FIG. 1A in the range from room temperature (e.g. about 27° C.) to 400° C. at a magnetic field of 140 Oe.

FIG. 1F is a plot of the temperature dependence of magnetization for Mn_{0.7}Zn_{0.3}Fe₂O₄ CNP at applied magnetic fields of 50, 80, 100, and 140 Oe.

FIG. 2A shows the X-ray powder diffraction (XRD) plot for the spinel phase formation of Mn_{0.8}Zn_{0.2}Fe₂O₄ and Mn_{0.9}Zn_{0.1}Fe₂O₄.

FIG. 2B is a plot of magnetic hysteresis loops measured at room temperature (about 27° C.) using PPMS for the CNPs of FIG. 2A.

FIG. 2C is a plot of normalized magnetization as a function of temperature for the CNPs of FIG. 2A in the range from room temperature (e.g. about 27° C.) to 500° C. at a magnetic field of 100 Oe.

FIG. 3A shows a Fourier transform-infrared spectroscopy (FTIR) spectra for the ferrite phase formation of Mn_{0.5}Zn_{0.5}Fe₂O₄, Mn_{0.6}Zn_{0.4}Fe₂O₄ and Mn_{0.7}Zn_{0.3}Fe₂O₄.

FIG. 3B shows a FTIR spectra of OA (oleic acid), BADGE (bisphenol A diglycidyl ether) and OA+BADGE.

FIG. 3C shows a FTIR spectra of OA- and BADGE-modified CNPs. The “*” denotes presence of OA and BADGE.

FIG. 3D is a plot of the weight percent coating analyzed from the change in weight with temperature measured using thermogravimetric analysis (TGA).

FIG. 3E is a plot depicting thermal degradation patterns of OA, BADGE and OA+BADGE.

FIG. 3F is a dynamic light scattering (DLS) plot that depicts the particle size stability with time for functionalized CNPs in ethanol.

FIG. 4A is a plot of the weight percent coating analysed from the change in weight with temperature measured using TGA.

FIG. 4B is a FTIR spectra for the ferrite phase formation of Mn_{0.8}Zn_{0.2}Fe₂O₄ and Mn_{0.9}Zn_{0.1}Fe₂O₄.

FIG. 4C is a FTIR spectra of OA- and BADGE-modified CNPs. The “*” denotes presence of OA and BADGE.

FIG. 4D is a plot of the weight percent coating for Mn_{0.7}Zn_{0.3}Fe₂O₄ particles coated with oleic acid (OA) and polycaprolactone (PCL).

FIG. 4E is a FTIR spectra of bare Mn_{0.7}Zn_{0.3}Fe₂O₄, OA and PCL.

FIG. 4F is a FTIR spectra of PCL and OA- and PCL-modified Mn_{0.7}Zn_{0.3}Fe₂O₄.

FIG. 5 is a dynamic light scattering (DLS) plot that compares the colloidal stability with time for bare CNPs and functionalized CNPs in ethanol.

FIG. 6A shows zero field cooled (ZFC), field cooled cooling (FCC) and field cooled warmed (FCW) magnetization curves of Mn_{0.4}, Mn_{0.5}, Mn_{0.6} and Mn_{0.7} nanoparticles measured at an applied magnetic field of 140 Oe and temperature range of 5 K to 400 K.

FIG. 6B shows ZFC, FCC and FCW magnetization curves of coated Mn_{0.7} in the temperature range of 5 K to 400 K at an applied magnetic field of 100 Oe, 140 Oe, 250 Oe and 500 Oe.

FIG. 7A shows a transmission electron micrograph (TEM) image for Mn_{0.7}Zn_{0.3}Fe₂O₄. Scale bar denotes 50 nm.

FIG. 7B shows the particle size distribution for Mn_{0.7}Zn_{0.3}Fe₂O₄.

FIG. 7C shows a TEM image for Mn_{0.7}Zn_{0.3}Fe₂O₄/OA/BADGE. Scale bar denotes 50 nm.

FIG. 7D shows the particle size distribution for Mn_{0.7}Zn_{0.3}Fe₂O₄/OA/BADGE.

FIG. 8A shows the alternating magnetic field (AMF) heating curves for 5-30 wt. % loading of functionalized Mn_{0.5}Zn_{0.5}Fe₂O₄/OA/BADGE CNP into bisphenol A diglycidyl ether (BADGE) at 140 Oe.

FIG. 8B shows the AMF heating curves for 5-30 wt. % loading of functionalized Mn_{0.6}Zn_{0.4}Fe₂O₄/OA/BADGE CNP into bisphenol A diglycidyl ether (BADGE) at 140 Oe.

FIG. 8C shows the AMF heating curves for 5-30 wt. % loading of functionalized Mn_{0.7}Zn_{0.3}Fe₂O₄/OA/BADGE CNP into bisphenol A diglycidyl ether (BADGE) at 140 Oe.

FIG. 8D is a plot of the AMF heating curves at varying field strength of 50, 80, 100 and 140 Oe for 15 wt. % functionalized Mn_{0.7}Zn_{0.3}Fe₂O₄/OA/BADGE CNP.

FIG. 9A shows the AMF heating curves for the different loadings (5-20 wt. %) of functionalized Mn_{0.8}Zn_{0.2}Fe₂O₄/OA/BADGE CNPs in glycerol diglycidyl ether (GDE) at 140 Oe.

FIG. 9B shows the AMF heating curves for the different loadings (1-20 wt. %) of functionalized Mn_{0.9}Zn_{0.1}Fe₂O₄/OA/BADGE CNPs in glycerol diglycidyl ether (GDE) at 140 Oe. Field strength was increased every 300 seconds for 20 wt. % loading.

FIG. 10A is a plot of temperature increase per second with mass of Curie nanoparticles (m_{CNP}) for Mn_{0.5}Zn_{0.5}Fe₂O₄/OA/BADGE (Mn_{0.42}), Mn_{0.6}Zn_{0.4}Fe₂O₄/OA/BADGE (Mn_{0.53}) and Mn_{0.7}Zn_{0.3}Fe₂O₄/OA/BADGE (Mn_{0.63}).

FIG. 10B shows the specific adsorption rate (SAR) with maximum AMF heating (Tₘₐₓ) for different formulations of Mn_{0.42}, Mn_{0.53} and Mn_{0.63.}

FIG. 11A shows photographs of a digital model (CAD) used to print ABS coupons by 3D printer (top left image), ABS coupons with magneto-adhesive cured under AMF (bottom left image), an organized setup for mechanical test (center image), and the bond/ABS breaking after mechanical test (right image). ABS denotes for acrylonitrile butadiene styrene.

FIG. 11B is a stress-strain curve of cured ES558 with ABS (ES558 @ ABS) with 20 wt. % CNP.

FIG. 11C is a plot of lab shear adhesion strength of magnetocured ES558 @ ABS with different loadings of CNP.

FIG. 11D is a plot of lab shear adhesion strength of different magneto-cured adhesives with ABS (Adh. @ABS) with 30 wt. % loading of CNP.

FIG. 11E is a plot of lab shear adhesion strength of magnetocured ES558 with different adherent materials with 30 wt. % loading of CNP.

FIG. 11F is a plot of lab shear adhesion strength of oven- and AMF-cured adhesives with glass (adhesives @ glass). Data presented as mean±SD, n=3 and significance is determined by one-way ANOVA, at p<0.05.

FIG. 12A shows the surface temperature during AMF curing for different adherents.

FIG. 12B shows the temperature of magnetoadhesive curing in AMF process measured by fibre optic thermocouple and FLIR camera. Scale bars in inset denote 10 mm.

FIG. 12C is a TGA-DSC plot for clean, oven- and AMF-cured ES558.

FIG. 12D is an attenuated total reflection (ATR) FTIR spectra of clean ES558 and AMF-cured ES558 magnetoadhesive.

FIG. 13A is a plot of magnetization as a function of temperature for MnₓZn₁₋ₓFe₂O₄ CNPs at a magnetic field strength of 100 Oe.

FIG. 13B is a plot of magnetization as a function of temperature for MnₓZn₁₋ₓFe₂O₄ CNPs at a magnetic field strength of 140 Oe.

FIG. 14A shows the temperature profile of CaproGlu curing in AMF process measured by fibre optic thermocouple.

FIG. 14B shows the storage/loss modulus of magnetocured sample with 10 wt. % Mn_{0.7}Zn_{0.3}Fe₂O₄/OA/PCL.

FIG. 14C shows the lap shear adhesion strength of magnetocured bone sample with 50 wt. % Mn_{0.7}Zn_{0.3}Fe₂O₄/OA/BADGE.

FIG. 15A shows an AMF heating plot for 5 wt. % Mn_{0.9}Zn_{0.1}Fe₂O₄/OA/BADGE in glycerol diglycidyl ether (GDE) at varying magnetic field strengths of 60, 80, 100, 120 and 140 Oe, wherein there is zero loading of carbon nanotubes (CNTs).

FIG. 15B shows an AMF heating plot for the CNPs of FIG. 15A except there is 0.5 wt. % loading of CNTs.

FIG. 15C shows an AMF heating plot for the CNPs of FIG. 15A except there is 1 wt. % loading of CNTs.

FIG. 15D shows an AMF heating plot for the CNPs of FIG. 15A except there is 2 wt. % loading of CNTs.

FIG. 16 shows an AMF heating plot of 5 wt. % Mn_{0.9}Zn_{0.1}Fe₂O₄/OA/BADGE in glycerol diglycidyl ether (GDE) incorporated with 0-4 wt. % of carbon nanocoils (CNCs) at AMF of 140 Oe.

FIG. 17A shows the effect of an alternating magnetic field (140 Oe) on carbon nanotubes (CNTs) and carbon nanocoils (CNCs), wherein 1 wt. % of CNTs and CNCs are dispersed in GDE.

FIG. 17B shows the effect of an alternating magnetic field (140 Oe) on carbon nanotubes (CNTs) and carbon nanocoils (CNCs), wherein 1 wt. % of CNTs and CNCs are dispersed in ethanol.

FIG. 18A shows a photograph demonstrating for recording surface temperature by fibre optic thermocouple during AMF curing with ABS for 10 mins.

FIG. 18B shows the surface temperature recorded for 5-30 wt. % loading of CNP in BADGE using the setup of FIG. 18A.

FIG. 18C is a TGA plot for demonstrating thermal stability of epoxy resin (glycerol diglycidyl ether, GDE and bisphenol A diglycidyl ether, BADGE) and epoxy adhesive, Permabond ES558.

FIG. 18D is a DSC plot showing the activation temperature of epoxy resin (glycerol diglycidyl ether, GDE and bisphenol A diglycidyl ether, BADGE) and epoxy adhesive, Permabond ES558.

FIG. 19 shows the lap shear adhesion strength of magnetocured ABS with 10-30 wt. % CNP+BADGE, cured at 140 Oe AMF. Data presented as mean±SD, n=3 and significance is determined by one-way ANOVA, at p<0.05. N.S. denotes for not significant difference.

FIG. 20 shows the ABS coupon of FIG. 11A with the magneto-adhesive of the present disclosure cured under AMF.

### DETAILED DESCRIPTION

The following detailed description refers to the accompanying drawings that show, by way of illustration, specific details and embodiments in which the present disclosure may be practised.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the present disclosure, there is provided an adhesive additive for magnetically curing an adhesive. Details of various embodiments of the adhesive additive are now described below and advantages associated with the various embodiments are demonstrated in the examples.

The adhesive additive can include a magnetic nanoparticle that includes (i) a metal, wherein the metal includes iron, manganese, cobalt, nickel, and/or zinc, or (ii) a metal oxide, wherein the metal oxide contains a metal which includes iron, manganese, cobalt, nickel, and/or zinc. Understandably, the metal oxide includes oxygen. The adhesive additive can include a coating on the magnetic nanoparticle. The coating can include (a) a surfactant or an inorganic material, and (b) a monomer or a polymer which may be miscible with an adhesive substrate which the adhesive additive can be incorporable to. The magnetic nanoparticles can produce thermal energy in response to an alternating magnetic field applied thereto for the adhesive substrate to form cross-linkages.

In various embodiments, the magnetic nanoparticle may be herein termed a “Curie nanoparticle”, which is abbreviated as CNP. The magnetic nanoparticle is termed herein a CNP as the magnetic nanoparticle has a Curie temperature, above which it may temporarily lose its magnetic properties. In other words, CNP of the present disclosure may produce thermal energy upon application of an alternating magnetic field, but upon reaching a certain temperature, the thermal energy produced from the CNP may be diminished or become unavailable as the CNP loses its magnetic properties and hence, may not produce any thermal response to the alternating magnetic field applied. In various embodiments, the magnetic nanoparticle may have a Curie temperature, for example, ranging from 60° C. to 300° C.

In various embodiments, the magnetic nanoparticle may contain one or more metals. For instance, the magnetic nanoparticle may include iron and zinc. In another instance, the magnetic nanoparticle may include iron, zinc and another metal (such as cobalt, manganese, or nickel). In various embodiments, the magnetic nanoparticle may be represented by a formula of AₓZn₁₋ₓFe₂O₄, wherein A may be cobalt, manganese, or nickel, and x may have a value in the range of 0.4 to 0.99, 0.4 to 0.9, 0.4 to 0.8, 0.4 to 0.7, 0.4 to 0.6, 0.4 to 0.5, 0.8 to 0.9, etc. In various embodiments, x may be 0.4, 0.5, 0.6, 0.7, 0.8, or 0.9.

As mentioned above, the coating can include (a) a surfactant or an inorganic material, and (b) a monomer or a polymer which may be miscible with an adhesive substrate which the adhesive additive can be incorporable to. The coating aids in colloidal stability of the magnetic nanoparticle in the adhesive substrate. The coating need not form cross-linkages with the adhesive substrate. The interaction of the monomer or polymer with the adhesive substrate may be non-covalent and may be primarily Van der Waals attractions and dipole-dipole interactions, wherein attraction between the coated magnetic nanoparticle and the adhesive substrate is greater than between coated magnetic nanoparticles such that aggregation of the magnetic nanoparticles are avoided and to have colloidal stability. Colloidal stability of the magnetic nanoparticles within the adhesive may also occur by displacement of intermediate organic shells for inclusion in organic environments (e.g. an organic adhesive such as a resin).

In various embodiments, the surfactant may be formed as an organic coating. The organic coating may be less than 10 nm in thickness. The organic coating may include a fatty acid having 15 to 20 carbon atoms. The fatty acid may include or may consist of oleic acid. In various embodiments, the surfactant may include oleic acid. In various embodiments, the surfactant may be covalently bonded to the magnetic nanoparticle.

In certain non-limiting embodiments, the coating may include an inorganic material. The inorganic material may include or may be a ceramic. The ceramic may include or may be silica or alumina. In various embodiments, the inorganic material may include or may be silica, alumina, carbon, or glass. In the resultant adhesive additive, the inorganic material may be formed directly on the magnetic nanoparticle, i.e. there is no organic surfactant between and contiguous to both the inorganic material and magnetic nanoparticle.

In various embodiments, the monomer and/or polymer may contain or may be a nucleophile, such as an amine, a hydroxy, a carboxylic acid, an ester, and/or a thiol.

In various embodiments, the monomer may include an epoxy. The monomer may include bisphenol A diglycidyl ether and/or glycerol diglycidyl ether.

In various embodiments, the adhesive additive may be absent of a hardener. In certain embodiments, the monomer may further include a hardener. The hardener may include or may be a dicyandiamide.

In various embodiments, the polymer may include or may be polycaprolactone.

In various embodiments, the adhesive additive may further include a carbon allotrope. The carbon allotrope may be a carbon nanotube or a carbon nanocoil. Such carbon allotropes confer better control of the magnetically-induced heating from the magnetic field applied.

In various embodiments, the alternating magnetic field applied may have a frequency of 100 kHz to 1 MHz and/or a magnetic field strength of 50 Oe to 140 Oe.

The present adhesive additive provides for magnetocuring of adhesives, which in turn confers numerous advantages in energy efficiency and tunable on-demand activation. Magnetocuring involves application of a magnetic field to a magnetic material to produce a thermal response, which in turn renders curing of the adhesives. As such, the present adhesive additive may be termed herein an “adhesive modifier” or simply a “modifier”. The present adhesive additive offers such an advantage, without compromising the properties of the adhesives. For instance, the present adhesive additive is miscible with the adhesive substrate. In other words, the presence of the adhesive additive does not cause the resultant adhesive to fail in strength when incorporated therein. The adhesion strength of the adhesives demonstrated herein can have a range of 1-7 MPa.

The present adhesive additive can be homogeneously distributed therein, which does not create uneven local hotspots when subjected to the alternating magnetic field. The present adhesive additive, which includes a CNP, prevents scorching, as the CNP can stop producing thermal energy once it reaches its Curie temperature, thereby preventing overheating (e.g. scorching) of the adhesive.

Advantageously, as the present adhesive additive can be used to produce heat for curing by applying a magnetic field, the heating and hence curing can be controlled remotely (without touching the adhesive additive or adhesive substrate). The activation temperature of the magneto-adhesive through application of an alternating magnetic field for heating can be reached in 5 minutes or less. From this, the curing can begin in 10 minutes or less, and be completed in a period of 30-60 minutes. Moreover, there is reduced processing cost and energy as the present adhesive additive can produce heat by applying lower frequency of 400 kHz and magnetic field strength of 50-140 Oersted (Oe) at maximum.

The present disclosure also provides for an adhesive which is magnetically curable. As such, the adhesive may be termed herein as a “magneto-adhesive”. The present adhesive can be used to join a range of materials, e.g. ceramics, polymer/plastic (e.g. PMMA (poly(methyl methacrylate)) and ABS (acrylonitrile butadiene styrene)), wood and animal bone. Polymer materials, wood and animal bone are difficult or almost impossible to join using traditional oven method.

In various embodiments, the adhesive includes the adhesive additive described in various embodiments of the first aspect, and an adhesive substrate. The term “adhesive substrate” may be used herein interchangeably with “adherent”. Embodiments and advantages described for the adhesive additive of the first aspect can be analogously valid for the present adhesive subsequently described herein, and vice versa. As the various embodiments and advantages of the adhesive additive and adhesive have already been described above and in the examples demonstrated herein, they shall not be iterated for brevity.

In various embodiments, the adhesive substrate may be a resin that includes or is a thermoset which can be activated to form cross-linkages by the thermal energy produced from the magnetic nanoparticle in the adhesive additive described in various embodiments of the first aspect. The thermoset may include or may be epoxy and diazirine. Thermosets having known activation temperature (e.g. 60° C. to 300° C.) of curing may be used. In certain embodiments, the adhesive substrate may be a resin that includes or is a thermoplastic. The thermoplastic may include or may be polycaprolactone. A thermoset differs from a thermoplastic in that thermoset cannot be remolded after curing while thermoplastic may be remolded with heat.

In various embodiments, the adhesive substrate may be a resin absent of a hardener.

In various embodiments, the adhesive additive and the adhesive substrate may be present in a weight ratio of 1:100 to 50:100, 10:100 to 50:100, 20:100 to 50:100, 30:100 to 50:100, 40:100 to 50:100, etc.

In the present disclosure, there is further provided a method of forming the adhesive additive described in various embodiments of the first aspect. Embodiments and advantages described for the adhesive additive of the first aspect can be analogously valid for the present method subsequently described herein, and vice versa. As the various embodiments and advantages of the adhesive additive and method have already been described above and in the examples demonstrated herein, they shall not be iterated for brevity.

The method may include providing a magnetic nanoparticle that may include (i) a metal, wherein the metal includes iron, manganese, cobalt, nickel, and/or zinc, or (ii) a metal oxide, wherein the metal oxide contains a metal which includes iron, manganese, cobalt, nickel, and/or zinc, mixing an aqueous solution that may include the magnetic nanoparticle with a surfactant, and mixing an organic solution that may include the magnetic nanoparticle coated with the surfactant with (i) a monomer or (ii) a polymer which may be miscible with an adhesive substrate which the adhesive additive is incorporable to. Understandably, the metal oxide includes oxygen. Said differently, the present method provides for forming the adhesive additive having the surfactant in the coating.

In various embodiments, providing the magnetic nanoparticle may include mixing an alkaline solution with two precursor solutions to form an alkaline mixture, and hydrothermally treating the alkaline mixture to form the magnetic nanoparticle. The alkaline solution may contain a first metal precursor and each of the two precursor solutions may contain a second metal precursor and a third metal precursor, respectively, to form different metals in the magnetic nanoparticle. In other words, the first, second and third metal precursors are different. Each of the first, second and third metal precursors may distinctly contain iron, manganese, cobalt, nickel, or zinc. Accordingly, the metal in the magnetic nanoparticle formed from the first, second and third metal precursors may include iron, manganese, cobalt, nickel, and/or zinc. As a non-limiting example, the alkaline solution may contain an iron precursor for forming the iron in the magnetic nanoparticle. The two precursor solutions may contain manganese and zinc as the second and third metal precursors, respectively. From such metal precursors, the resultant magnetic nanoparticle may contain iron, manganese and zinc.

In various embodiments, mixing the aqueous solution that includes the magnetic nanoparticle with the surfactant may include dispersing the magnetic nanoparticle in an aqueous medium, and mixing the aqueous medium with the surfactant.

In various embodiments, the surfactant may include or may be a fatty acid having 15 to 20 carbon atoms.

In various embodiments, mixing the organic solution that includes the magnetic nanoparticle coated with the surfactant with (i) the monomer or (ii) the polymer may include dispersing the magnetic nanoparticle coated with the surfactant in an organic medium, dissolving the monomer or the polymer in an organic solvent to form a monomer solution or a polymer solution, respectively, and mixing the monomer solution or the polymer solution with the organic medium containing the magnetic nanoparticle coated with the surfactant.

In various embodiments, the method may further include adding the adhesive additive in a further resin, and mixing a carbon allotrope with the further resin containing the adhesive additive.

The present disclosure provides another method of forming the adhesive additive described in various embodiments of the first aspect. Embodiments and advantages described for the adhesive additive of the first aspect can be analogously valid for the present method subsequently described herein, and vice versa.

Embodiments and advantages described for the other method mentioned above may be analogously valid and/or applicable for the present method subsequently described herein, and vice versa. Where the various embodiments and advantages of the adhesive additive described above and in the examples demonstrated herein are applicable, they shall not be iterated for brevity. Where the various embodiments and advantages of the other method described above and in the examples demonstrated herein are applicable, they shall not be iterated for brevity.

The present method may include providing a magnetic nanoparticle that includes (i) a metal, wherein the metal includes iron, manganese, cobalt, nickel, and/or zinc, or (ii) a metal oxide, wherein the metal oxide contains a metal which includes iron, manganese, cobalt, nickel, and/or zinc, forming one or more surfactants on the magnetic nanoparticle, forming an inorganic precursor on the one or more surfactants, calcinating the magnetic nanoparticle with the inorganic precursor to remove the one or more surfactants and to form an inorganic material coated on the magnetic nanoparticle, and mixing an organic mixture that includes the magnetic nanoparticle coated with the inorganic material with (i) a monomer or (ii) a polymer which is miscible with an adhesive substrate which the adhesive additive is incorporable to. Said differently, the present method provides for forming the adhesive additive having an inorganic material in the coating.

In various embodiments of the present method and as described in the other method mentioned above, providing the magnetic nanoparticle may include mixing an alkaline solution with two precursor solutions to form an alkaline mixture, wherein the alkaline solution contains a first metal precursor, wherein each of the two precursor solutions contains a second metal precursor and a third metal precursor, respectively, wherein the first metal precursor, the second metal precursor, and the third metal precursor form different metals in the magnetic nanoparticle, and hydrothermally treating the alkaline mixture to form the magnetic nanoparticle.

In various embodiments of the present method, the one or more surfactants may include oleic acid, hexadecyltrimethylammonium bromide, and/or 1-butanol. The one or more surfactants in the present method aid in coating the inorganic material on the present magnetic nanoparticle. The one or more surfactants may also include a fatty acid having 15 to 20 carbon atoms, wherein oleic acid is one non-limiting example. The one or more surfactants may include at least two surfactants. Other suitable surfactants that aid coating an inorganic material on the present magnetic nanoparticle may be used. Non-limiting examples of the surfactants are demonstrated in the examples section.

In various embodiments of the present method, forming the inorganic precursor on the one or more surfactants may include mixing the magnetic nanoparticle having the one or more surfactants with the inorganic precursor for forming the inorganic material. The inorganic precursor for forming alumina as the inorganic material may include aluminum isopropoxide, aluminum hydroxide, and/or alumina. The inorganic precursor for forming silica as the inorganic material may include tetraethyl orthosilicate. The inorganic precursor for forming carbon as the inorganic material may include starch, glucose, and/or activated carbon (e.g activated charcoal). The inorganic precursor for forming glass as the inorganic material may include fused silica, bioglass and/or calcium sodium phosphosilicate. In various embodiments, the inorganic precursor may include tetraethyl orthosilicate, aluminum isopropoxide, aluminum hydroxide, alumina, starch, glucose, activated carbon, fused silica, bioglass, and/or calcium sodium phosphosilicate.

In various embodiments of the present method, calcinating the magnetic nanoparticle with the inorganic precursor to remove the one or more surfactants and to form the inorganic material coated on the magnetic nanoparticle may include heating the magnetic nanoparticle with the inorganic precursor at a temperature of at least 500° C., 500° C. to 600° C., 550° C., etc.

In various embodiments of the present method, mixing the organic mixture including the magnetic nanoparticle coated with the inorganic material with (i) the monomer or (ii) the polymer may include dispersing the magnetic nanoparticle coated with the inorganic material in an organic medium, dissolving the monomer or the polymer in an organic solvent to form a monomer solution or a polymer solution, respectively, mixing the monomer solution or the polymer solution with the organic medium containing the magnetic nanoparticle coated with the inorganic material. The steps for preparing the monomer solution and polymer solution described in the other method mentioned above may be applicable for the present method.

In various embodiments of the present method and as described in the other method mentioned above, the present method may further include adding the adhesive additive in a further resin, and mixing a carbon allotrope with the further resin containing the adhesive additive.

To demonstrate for the various embodiments described above, some non-limiting examples are briefly discussed below and in more detail in the examples section further below.

Development of several magneto-adhesives involved readily available adhesives and BADGE-DICY (bisphenol A diglycidyl ether-dicyandiamide). These examples may involve charging CNP and adhesives in the ratio between 10 to 50 wt. %. Particularly, the ratios of the components may be CNP: ES558=15-30 wt. %, CNP: TIM 813HTC=30 wt. %, CNP: BADGE-DICY=30 wt. %, CNP: CaproGlu=10 wt. % and 50 wt. %, etc. Holistically, the present disclosure provides an improved method over existing methods. The present adhesive additive, adhesive and method, may be deemed a one-pot adhesive platform that allows non-contact ‘magnetocuring’ through exposure to alternating magnetic fields. Curie nanoparticles (CNPs) interact with the alternating magnetic fields, where magnetic hysteresis heats the surrounding fluids or resin. The present CNPs have the advantage of possessing a programmable temperature limit that can be controlled by, for example, a Mn/Zn ratio. The temperature control prevents scorching, i.e. a detrimental property of other magnetic nanoparticles. The Mn/Zn ratio can be tuned through the hydrothermal synthesis feedstocks. Ratios of Mn_{0.4}Zn_{0.6} to Mn_{0.7}Zn_{0.3} are demonstrated in the examples section as they span cutoff temperatures of 100-250° C., which overlaps most thermoset resins.

The present disclosure provides an additional transducing approach to govern the temperature of CNPs (e.g. Mn_{0.9}Zn_{0.1}Fe₂O₄) by introducing carbon allotropes, e.g. carbon nanotubes (CNT) and carbon nanocoils (CNC). Incorporation of CNT/CNC, increases thermal conductivity and shielding of magnetic fields, which improves the prevention of scorching and local heat generation.

To prevent aggregation and maximise shelf stability, the as-synthesized CNPs can be coated with a surfactant, e.g. oleic acid (OA). For phase transfer into resins, CNP/OA was functionalized with resin monomers. The present disclosure provides non-limiting examples of resin which includes epoxy (bisphenol A diglycidyl ether, BADGE and glycerol diglycidyl ether, GDE) and polycaprolactone (PCL, M.W.: 300 Da). Displacement of intermediate organic shells accomplishes the aim to interface with the resin/adhesive upon thermoset initiation.

Advantageously, the present CNPs are employable to cure one-component epoxy adhesives through non-contact alternating magnetic fields. The present modifier methodology allows its incorporation into existing thermoset adhesive formulations. The present magnetocuring offers a more cost-effective activation method, as the adhesive is heated directly without the need to heat the surface/material to be adhered.

Herein, the curing of one-component epoxy adhesives and bioadhesives through AMF activation or ‘magnetocuring’ is demonstrated on plastics, wood, ceramics, and animal bone, which is of significant interest in medical, sports, automotive, and aerospace industries.

The structure-activity relationships of the ratio of metals in the CNP, the adhesive additive percent loading, CNT/CNC percent loading and magnetic field strength are evaluated with respect to material properties and lap shear adhesion on industrial-relevant surfaces/materials.

The word “substantially” does not exclude “completely” e.g. a composition which is “substantially free” from Y may be completely free from Y. Where necessary, the word “substantially” may be omitted from the definition of the present disclosure.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

Unless specified otherwise, the terms “comprising” and “comprise”, and grammatical variants thereof, are intended to represent “open” or “inclusive” language such that they include recited elements but also permit inclusion of additional, unrecited elements.

### EXAMPLES

The present disclosure relates to an adhesive technology, which is capable of bonding various materials.

Traditional one-component adhesives typically cure using moisture, heat and light. Such curing approaches tend to limit applications to specific surfaces/materials, suffer inefficient handling in manufacturing, and most are only activated indirectly. To overcome these limitations, herein disclosed are one-pot epoxy adhesives capable of contactless curing with alternating magnetic fields (AMFs). Referred to as magnetocuring, the present approach offers an energy efficient method of on-demand adhesion through self-regulating Curie nanoparticles. Using AMF on, for example MnₓZn₁₋ₓFe₂O₄ Curie nanoparticles (CNPs) additives of the present disclosure that are incorporated within epoxy adhesives, the thermoset resins cured within minutes with minimal rise in temperature of the substrates. In situ heating can be controlled by the present CNP formulation, CNP loading, and strength of the applied AMF. Under certain conditions, internal temperatures of 160° C. could be reached in minutes, allowing curing of most commercial epoxy adhesives with no noticeable resin scorching. The maximum lap shear adhesion strength exceeded 6.5 MPa. Magnetocuring is demonstrated on wood, ceramics, and plastics, which is of considerable interest in sports, automotive, and aerospace industries.

In further detail, to overcome the limitations of traditional magnetocured adhesives, colloidal stability and aggregate-induced hotspots need to be addressed. Herein, it is described that surface-functionalized Curie magnetic nanoparticles (CNP) serve as magnetocuring additives within thermoset resins. This allows one-pot adhesive formulations that activate substrate bonding and adhesive crosslinking upon AMF exposure. The bonding initiation of adhesives can be precisely tuned to the Curie nanoparticle cutoff temperature with controlled heating, allowing bonding to heat-sensitive substrates while eliminating scorching. The Curie magnetic nanoparticles may include a metal or a metal oxide. Said differently, the Curie magnetic nanoparticles may be composed of a single metal, a combination of metals, a metal oxide having a single metal, or a metal oxide containing multiple metals. In certain non-limiting examples, the Curie magnetic nanoparticles may be metal magnetic nanoparticles formed from Fe, Mn, Co, Ni, Zn, or a combination thereof (e.g. Fe—Co, Fe—Mn—Zn). In certain non-limiting examples, the Curie magnetic nanoparticles may be metal oxide magnetic nanoparticles containing one or more metals, e.g. FeO, MnO, FeCoO₃, FeMnZn oxide.

In order to demonstrate this, the following structure-activity relationships were studied. (1) MnₓZn₁₋ₓFe₂O₄ CNPs are synthesized by simple hydrothermal method with controlled particle size (<20 nm) and Curie temperature (Tc). The Curie temperature of MnₓZn₁₋ₓFe₂O₄ ferrites can be finely tuned by changing the ratio of Mn to Zn. (2) Organic coatings and surface functionalization on CNPs with oleic acid and bisphenol A diglycidyl ether ameliorate previous laboratory failures with regard to long-term CNP colloidal stability in liquid epoxy/adhesives. (3) Incorporation of Curie nanoparticles into adhesives and AMF induction (low power system) that allow snap-curing formulations while preventing surface/material hotspots and scorching. (4) Lastly, the loading of CNPs, thermal and physical properties of adhesives, selection of adherent material allow tuning of the mechanical properties and shear adhesion strength upon exposure to AMF.

The present Curie nanoparticles, adhesives, and method of forming the Curie nanoparticles, are described in further details, by way of non-limiting examples, as set forth below.

### Example 1A: Materials

One component epoxy adhesives (ES558 Permabond and TIM-813HTC-1HP) are purchased from Permabond, USA and TIMTRONICS, USA, respectively. The divalent manganese (II) chloride tetrahydrate (MnCl₂·4H₂O, 99%), zinc chloride, anhydrous (ZnCl₂, 98%) and trivalent iron (III) chloride hexahydrate (FeCl₃·6H₂O), oleic acid (OA), bisphenol A diglycidyl ether (BADGE) and dicyanamide (DICY) are purchased from Sigma Aldrich and used as received. Wood popsicle sticks and polymethyl methacrylate (PMMA) sheets are purchased from Art Friend, Singapore. Acrylonitrile butadiene styrene (ABS-100) used for 3D printing is purchased from Additive 3D Asia, Singapore. Microscope slides, borosilicate (25.4 mm×76.2 mm, thickness 1-1.2 mm) are purchased from Newton 101 PTE. LTD. Singapore.

### Example 1B: Method—Synthesis of Magnetocuring Adhesive Modifier Curie Nanoparticles (CNP)

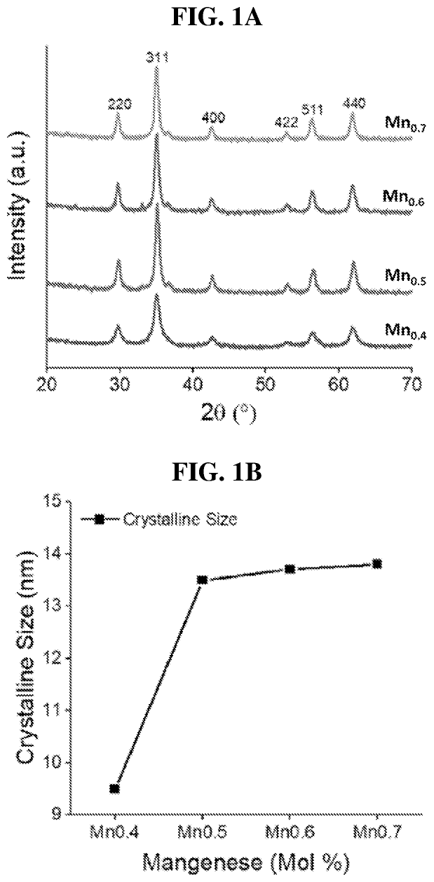

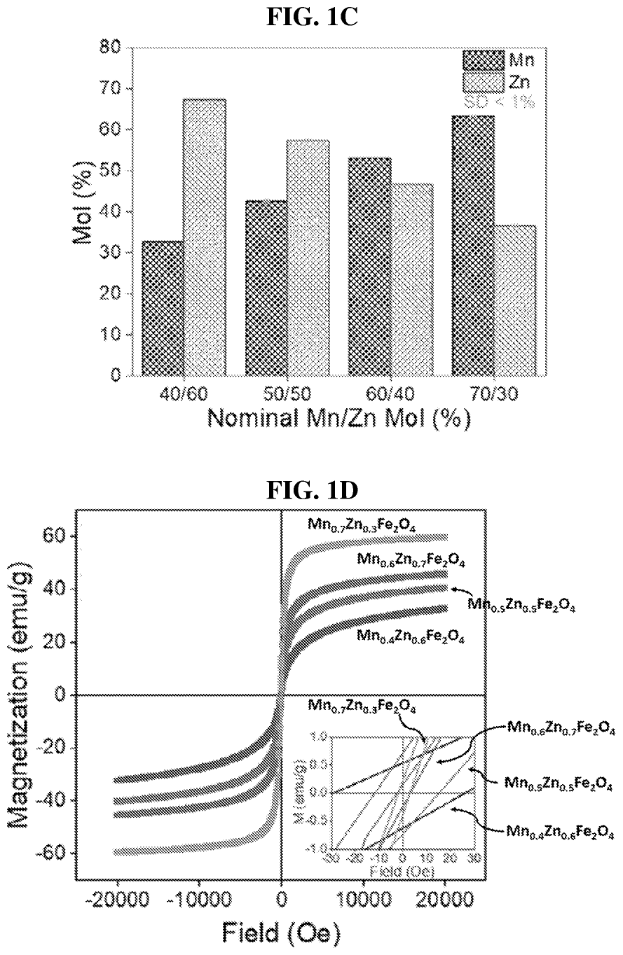

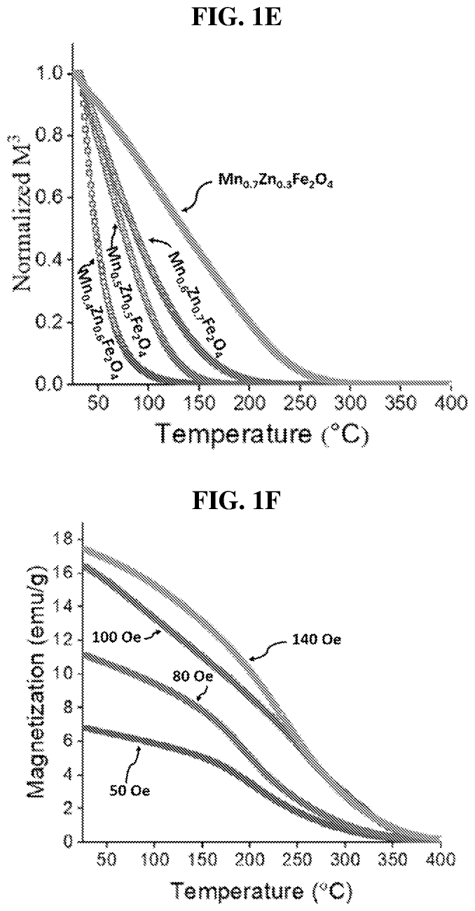

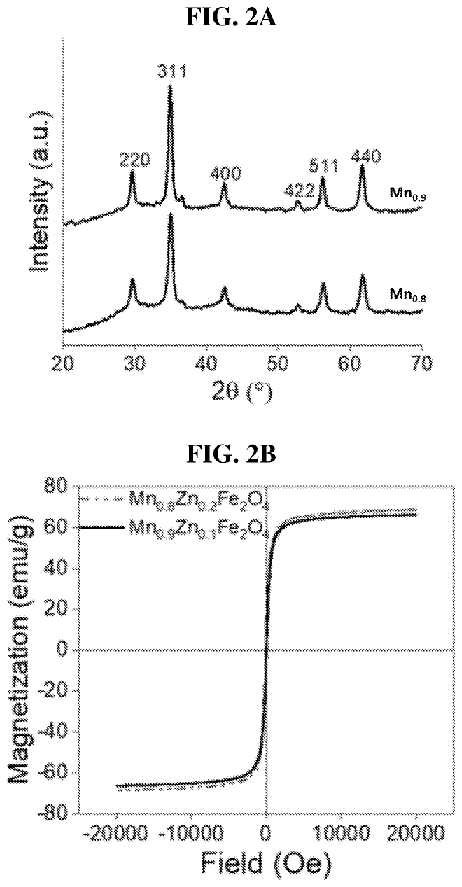

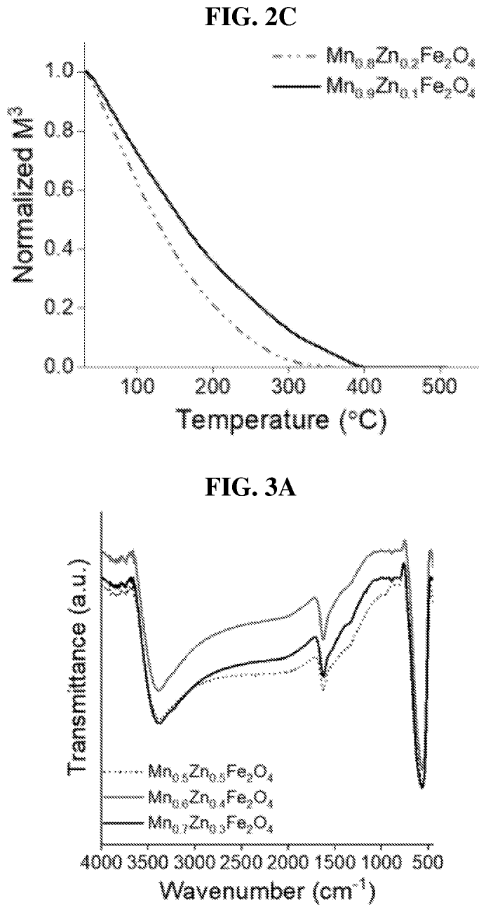

Magnetocuring additives (also termed adhesive modifier), using CNPs of composition MnₓZn₁₋ₓFe₂O₄ (e.g. x=0.4 to 0.9) as examples, are synthesized using a hydrothermal method. Briefly, for the synthesis of a 4 g batch of Mn_{0.7}Zn_{0.3}Fe₂O₄ particles, 10 mL solutions of 70 mmol MnCl₂·4H₂O (2.22 g) and 30 mmol ZnCl₂ (0.654 g) are prepared separately in distilled water (DI water). 200 mmol of FeCl₃·6H₂O (8.64 g) is dissolved in 40 mL DI water and NaOH (4M) solution is added dropwise until pH value reached 8. The resulting brown precipitate is centrifuged and washed three times with DI water, and transferred into a beaker equipped with mechanical stirrer. The separately prepared Mn and Zn salt solutions are then added together into the beaker and the mixed solution is stirred vigorously while adding NaOH solution dropwise until the pH value of the reaction mixture reached 12. This resulting slurry is decanted into a Teflon-lined stainless-steel autoclave (4748A Parr, USA) and placed in oven at 190° C. for 2 hrs. The resulting nanoparticles are washed three times with DI water and two times with ethanol (96%), followed by vacuum drying for 48 hrs. The 95% yield (3.8 g) of vacuum dried particles is obtained. All other CNPs (e.g Mn_{0.4}, Mn_{0.5}, Mn_{0.6}, Mn_{0.8} and Mn_{0.9}) are also synthesized in a similar way with 95-97% yield and stored under vacuum. Prior to further modification, all the synthesized CNPs are characterized for their structural, functional and magnetic properties using XRD, ICP-MS, TGA, FTIR, and PPMS (Physical Property Measurement System) (see FIGS. 1A to 1F and 2A to 2C).

### Example 2A: Method—Surface Modification of Curie Nanoparticles with Oleic Acid (OA) and Functionalization with Bisphenol a Diglycidyl Ether (BADGE) and Polycaprolactone (PCL)

CNPs are coated with a surfactant, oleic acid to prevent particles agglomeration. 2 g of CNPs are dispersed in 80 mL of deionized water and placed in a sonicating water bath (Elmasonic S 60 H, Germany) for 20 mins to break any formed aggregates. 4 mL of OA is added to the solution and sonicated for 10 min. This solution is heated at 80° C. for 1 hr under mechanical stirring at speed of 400 rpm. The resultant solution is washed 3-4 times with ethanol and the OA-coated CNPs are separated using a permanent magnet. The oleic acid-coated particles (MnₓZn₁₋ₓFe₂O₄/OA) are used as it is for the further functionalization with bisphenol A diglycidyl ether and polycaprolactone, individually.

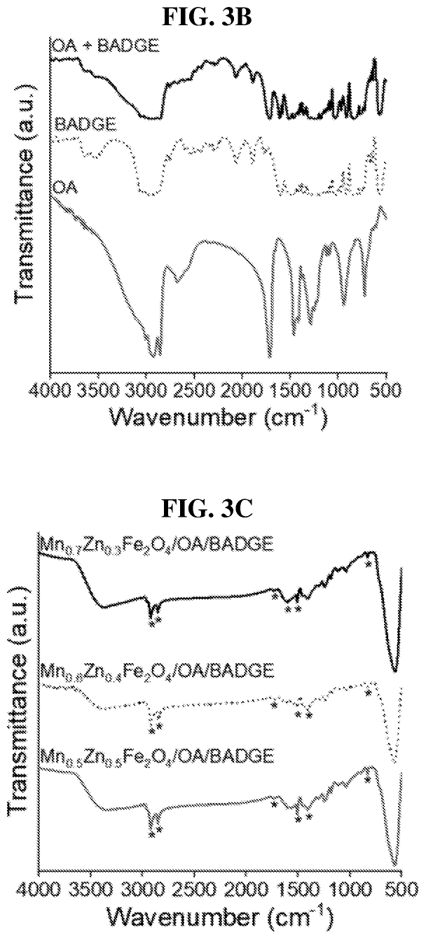

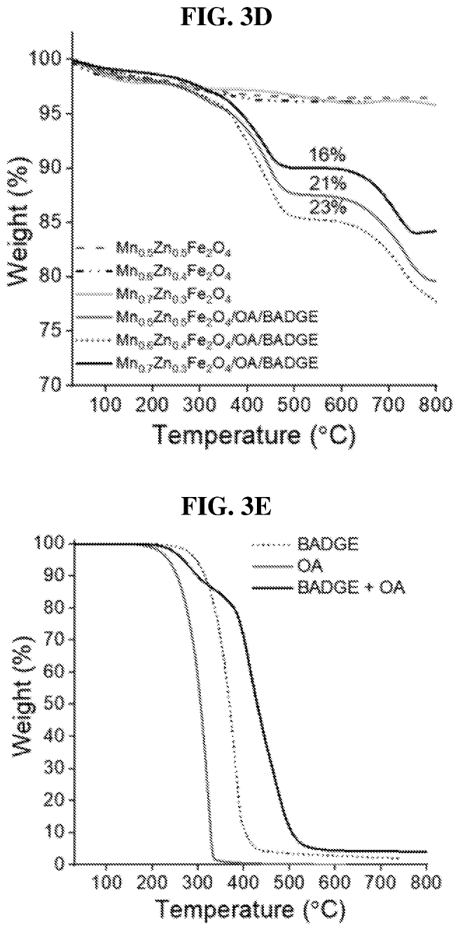

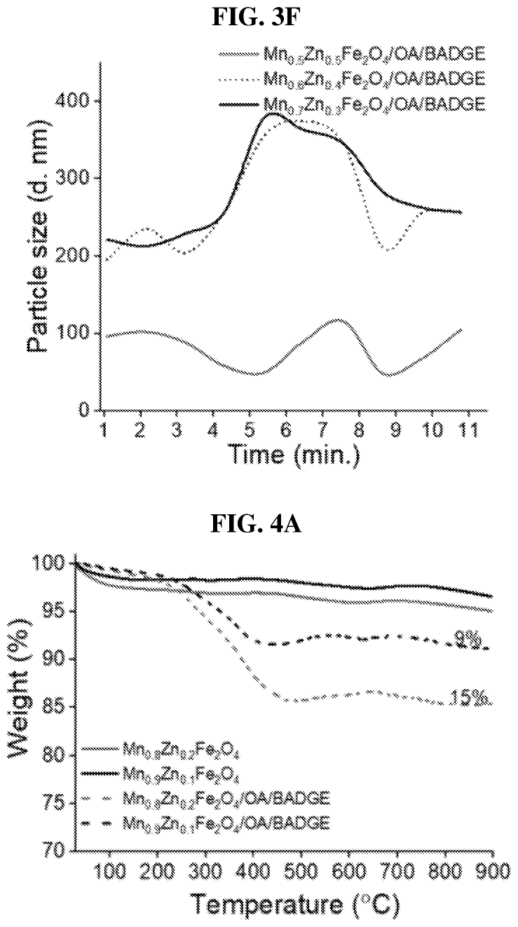

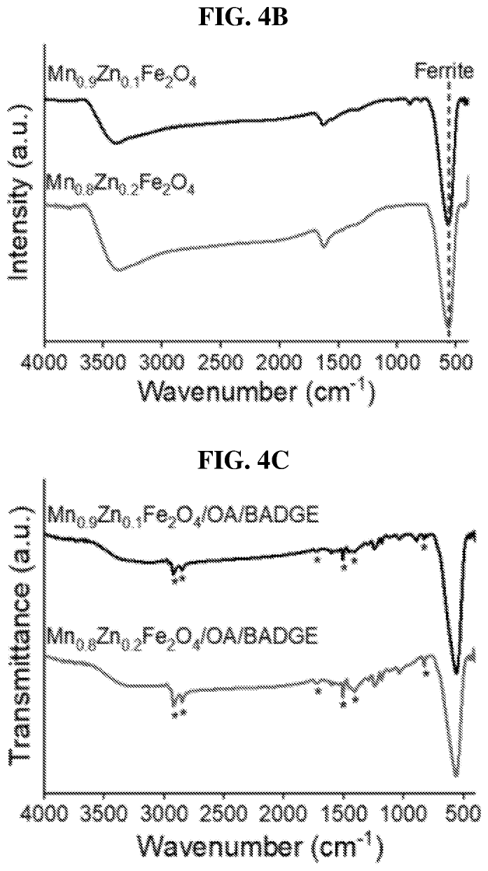

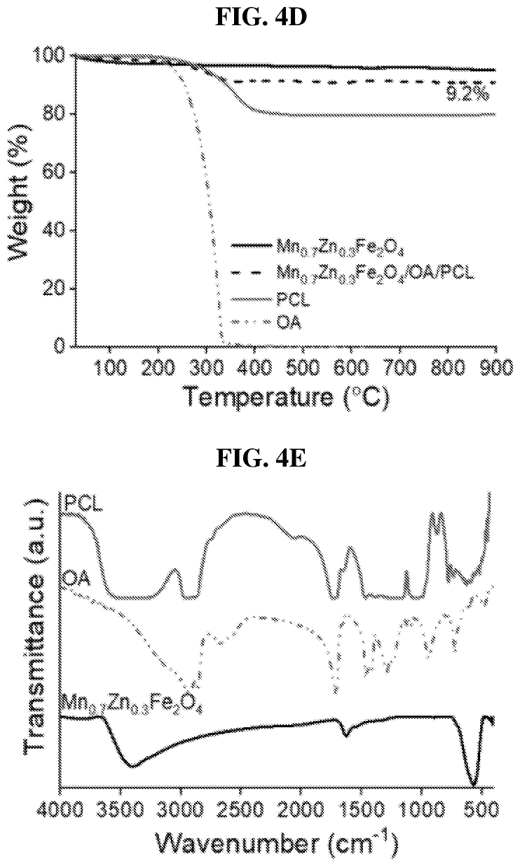

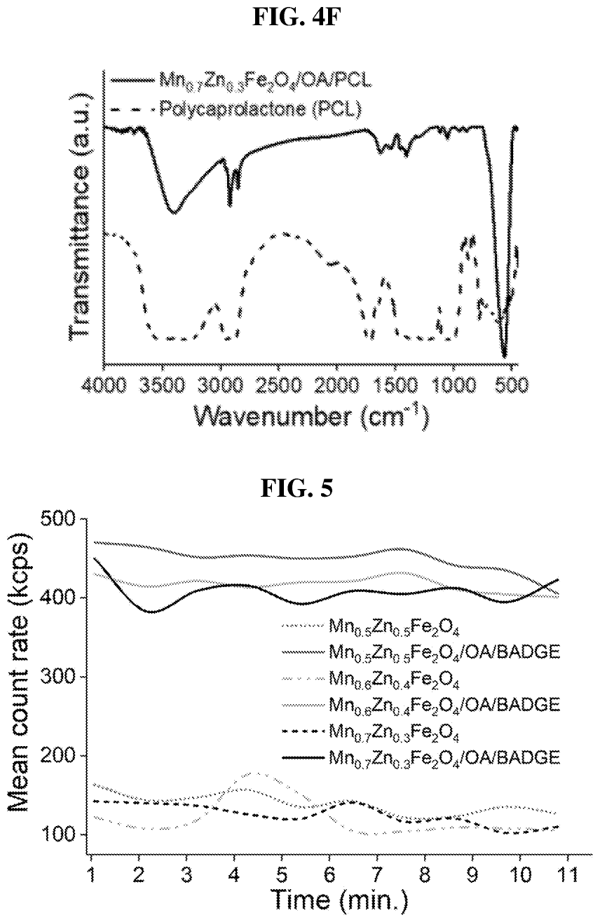

MnₓZn₁₋ₓFe₂O₄/OA particles described above are dispersed into 10 mL of tetrahydrofuran (THF) and sonicated for 30 minutes. After that, solution of 10 g bisphenol A diglycidyl ether (BADGE) in 20 mL THF is added to the above solution and sonicated again for 30 minutes. This solution is kept for 16 hrs until the surface of nanoparticles is completely wetted with BADGE. Next, MnₓZn₁₋ₓFe₂O₄/OA/epoxy nanocomposite is obtained by washing with tetrahydrofuran and acetone, separated using a permanent magnet and vacuum dried for 24 hrs. On the basis of dried particles weight, 1.94 g yield for the surface functionalization is observed. Same procedure is repeated for the functionalization of MnₓZn₁₋ₓFe₂O₄/OA particles with polycaprolactone of molecular weight (M.W.) 300 Da. The amount of OA, BADGE and PCL anchored on the surface of the functionalized particles is calculated by TGA and the functional group bounded is confirmed by FTIR (see FIGS. 3A to 3F and 4A to 4F).

### Example 2B: Method—Alternating Magnetic Field Heating of Functionalized CNPs

The alternating magnetic field (AMF) generator of D5 series (640W mono frequency F1 driver) from nB nanoScale Biomagnetics, Spain is used by incorporating a solenoid coil (S56) at fixed frequency of 400 kHz. AMF heating of the coated CNPs dispersed in BADGE at different concentrations (5-30 wt. %) are evaluated at applied magnetic field strengths ranging from 50 to 140 Oe. Temperature under AMF is measured using fibre optic temperature sensor (Neoptix T1S-01-PT15, USA). All the samples are freshly prepared by dispersing the appropriate amount of CNPs into BADGE and treated with ultrasound sonication for 60 minutes.

### Example 2C: Method—Specimen Preparation by 3D Printing

All the ABS coupons are printed using a Cubicon 3DP-110F printer. The T-shaped geometry of ABS coupons is created using Solidworks and saved as stereolithographic (STL) file. This STL file is opened in 3D printer software, set up the printing parameters and Gcode is exported to the printer. The dimensions of ABS coupons and printing parameters are listed in Table 1.

TABLE 1
Dimensions of ABS coupons and parameters used for 3D printing.

| Dimensions | Values | |
|---|---|---|
| Length | 90 | mm |
| Width | 20 | mm |
| Thickness | 3 | mm |

Printing parameters

| | | |
|---|---|---|
| Extruder temperature | 240° | C. |
| Bed temperature | 115° | C. |
| Chamber temperature | 45° | C. |
| Layer Height | 0.25 | mm |
| Wall thickness | 0.8 | mm |

| | |
|---|---|
| Infill | 20% |

### Example 2D: Method—Adhesives Curing by AC Magnetic Field

Commercially procured (Permabond ES558 and TIMTRONICS 813-HTC) and mixture of BADGE and dicyanamide (100:12) are used for the magnetocuring of one-component epoxy adhesives. Different loadings of CNPs (15-30 wt. %) with respect to the adhesive/BADGE are used as filler for the magnetocuring of wood, glass, PMMA and ABS coupons. Samples are cured at the magnetic field strength of 140 Oe and frequency of 400 kHz.

### Example 2E: Method—Structural and Magnetic Characterizations of CNPs

X-ray diffraction (XRD) was carried out with a Bruker D8 Advance powder diffractometer, using Cu-Kα radiation operated at 40 kV and 40 mA, in the range from 2θ=20° to 70°, at a scan rate of 5° min⁻¹. Phase identification was performed by matching diffraction peak positions and relative intensities to reference JCPDS files. The crystallite size was calculated using Scherrer formula D=0.9λ/(β cos θ), where λ is the wavelength of the X-rays (1.54 Å), β is the full width at half maximum (FWHM) of the 311 diffraction peak and θ is the Bragg angle.

### Example 2F: Method—Elemental Composition of CNPs

Elemental composition of synthesized Curie nanoparticles was measured by Inductively coupled plasma mass spectrometry (ICP-MS) Agilent 7700, Japan. Samples were prepared by dissolving the particles in a mixture of hydrochloric acid (HCl) and nitric acid (HNO₃) at a ratio of 3:1 followed by dilution with Millipore water. Prior to the analysis, the sample solution was filtered using 0.2 mm pore sized syringe filter (Agilent).

### Example 2G: Method—Physical Property Measurement of CNPs

Magnetic properties of CNPs were measured using PPMS (EverCool-II, Quantum Design, USA), equipped with a vibrating sample magnetometer and an oven (model P527). The room temperature hysteresis curves of the CNPs were recorded up to the applied field of 2 T. The magnetization versus temperature curves were measured in the temperature range of room temperature to 600° C. at different applied magnetic field strengths ranging from 50 Oe to 140 Oe.

### Example 2H: Method—Quantification of Coating on CNPs

Thermal degradation of bare Curie nanoparticles and the amount of OA and BADGE coated onto the nanoparticles were measured using thermogravimetric analysis (TGA). TGA was carried out using a TA Instruments TGA Q500 over a temperature range from 30 to 900° C. at a ramp rate of 10° C. min⁻¹ under nitrogen atmosphere.

### Example 21: Method—Colloidal Stability of CNPs

The stability of the Curie nanoparticles was examined using a Zetasizer (Zetasizer Nano, Malvern Instruments, UK), carrying out a 173° backscatter measurement. The colloidal stability of functionalized nanoparticles dispersed in ethanol was investigated by measuring the mean count rate (kilo count per second, kcps) versus time. 5 mg of CNPs (MnₓZn₁₋ₓFe₂O₄/OA/BADGE) are dispersed in 5 mL of ethanol and sonicated for 1 hr. For all the samples, ten measurements with ten repeated runs were recorded.

### Example 2J: Method—Curing Temperature from Differential Scanning Calorimetry (DSC)

DSC analysis was performed using simultaneous DSC/TGA system, TA Instrument, SDT Q600. Analysis was carried out from 30 to 600° C. at a ramp rate of 10° C. min⁻¹.

### Example 2K: Confirmation of CNPs Functionalization and Percentage Crosslinking

FTIR (Perkin Elmer Frontier) measurements of functionalized CNPs were performed using a universal Zn—Se ATR (attenuated total reflection) accessory in the 500-4000 cm⁻¹ region. The FTIR spectra of CNPs and functionalized CNPs were recorded by KBr pellet method. 3-4 mg of CNPs are added into 20 mg of potassium bromide (KBr) and mixed with mortar pestle. This mixture is used to prepare the pellet with 13 mm KBr die set by applying 10 tons of pressure via KBr hydraulic press (Specac, UK). The FTIR measurements of adhesives and cured adhesive are performed with a Universal ATR fixture of a ZnSe crystal. Each measurement is an accumulation of 32 scans with a resolution of 4 cm⁻¹.

### Example 2L: Method—Lap Shear Adhesion

Magnetocuring is demonstrated on different surfaces/materials: glass, wood, ABS and PMMA. 125 mg of adhesives are applied onto the surface/adherent section area of 1×1 cm². Thickness of the samples is maintained to be about 0.45 mm (±0.05) for all the surfaces. The adherents are tightly gripped together with cello-tape. The Lap shear adhesion tests of the magnetocured samples are performed on a Static Mechanical Tester (Criterion MTS C43, USA) with 2.5 kN load cell and testing speed of 3 mm/min.

### Example 2M: Method—Statistical Analysis

All the experiments are performed in triplicate and data presented here are mean±SD (n=3). Significance is evaluated by one-way ANOVA with Tukey correction, carried out using OriginPro 2018b 64-bit Software, where p<0.05. (*) is considered to be statistically significant.

### Example 2N: Method—Surface Modification of Curie Nanoparticles with Inorganic Material

To demonstrate inorganic material coating on the CNPs, Fe₃O₄ nanoparticles was used as a non-limiting example. Other metals and metal oxides can be used. The metals and metal oxides can contain more than one metal.

Fe₃O₄ nanoparticles were synthesized by a modified thermal decomposition method. In this example, 1.41 g of Fe(acac)₃ was added to a mixture of dibenzylether (30 mL), oleic acid (0.6 mL) and oleylamine (1.31 mL). Then, the temperature of the suspension was raised to 120° C. and held at this temperature for 30 mins under nitrogen atmosphere. Then, the mixture was quickly heated to 280° C. and kept at this temperature for 4 hrs. After cooling the suspension to room temperature, the solution was centrifuged at 10,000 rpm for 15 mins and washed by ethanol three times. Finally, the oleic acid-stabilized Fe₃O₄ nanoparticles were dispersed in chloroform for further use.

The Fe₃O₄ nanoparticles were then subject to a “phase transfer” step, which involves coating one or more other surfactants that aids the subsequent deposition of an inorganic precursor for forming the inorganic material on the Fe₃O₄ nanoparticles. 1 mL of the as-prepared Fe₃O₄ nanoparticles dispersed in chloroform was mixed with an aqueous solution containing 0.06 g hexadecyltrimethylammonium bromide (CTAB). The obtained macroemulsion was sonicated for 1 hr and then heated to 70° C. for 10 mins to evaporate chloroform leading to a stable transparent solution containing water dispersible Fe₃O₄ nanoparticles. To remove the excess surfactant from the nanoparticle suspension, the solution was cooled down to 5° C. and then centrifuged to separate the excess surfactant.

The CNPs with the inorganic material (e.g. silica) were then synthesized. Magnetic mesoporous silica CNPs were fabricated using a modified inverse microemulsion method involving CTAB/1-butanol/water/cyclohexane as surfactant/co-surfactant/aqueous phase/organic phase. 2 g of CTAB was added to a mixture of 1-butanol and cyclohexane at room temperature. Subsequently, 3 mL of an aqueous suspension containing CTAB-stabilized Fe₃O₄ nanoparticles and urea were added to the above solution, and a transparent microemulsion was formed. Then, a certain amount of tetraethyl orthosilicate (TEOS) was added to the microemulsion under vigorous stirring. The microemulsion containing TEOS was transferred to a 75 mL Teflon-lined autoclave and heated at the desired temperature (e.g. 70° C. to 170° C.) for 12 hrs. The formed core-shell Fe₃O₄@SiO₂ nanoparticles were collected by centrifugation (4000 rpm) and then washed with ethanol and water three times and then dried in an oven at 60° C. Finally, for the extraction of CTAB from the silica shell, a calcination process was utilized based on heating the nanocomposites at a temperature of at least 500° C. (e.g. 550° C.) for 6 hrs. The calcination may thermally remove the other surfactants used as mentioned above.

Subsequently, the monomer or polymer may be functionalized on the CNPs coated with the inorganic material based on the steps described in earlier examples, for instance, example 2A.

### Example 3A: General Summary of Results

A one-pot adhesive platform is designed to allow non-contact ‘magnetocuring’ through exposure to alternating magnetic fields. Curie nanoparticles (CNPs) interact with the alternating magnetic fields, where magnetic hysteresis heats the surrounding fluids. CNPs have the advantage of a programmable temperature limit controlled by the final Mn/Zn ratio. The temperature control prevents scorching, i.e. a detrimental property of other magnetic nanoparticles. The Mn/Zn ratio is tuned through the hydrothermal synthesis feedstocks and subsequently evaluated with X-ray diffraction. Ratios of Mn_{0.4}Zn_{0.6} to Mn_{0.7}Zn_{0.3} are chosen as they span cutoff temperatures of 100-250° C., which overlaps most thermoset resins. To prevent aggregation and maximise shelf stability, the as-synthesized CNPs are surface functionalized with oleic acid and BADGE. Oleic acid (OA) is used in nanoparticle synthesis because it can form a dense protective layer, which stabilizes nanoparticles. A surface coating of BADGE aims to interface with the resin upon thermoset initiation. Structure-activity relationships of CNP elemental ratio, additive percent loading, and magnetic field strength are evaluated with respect to material properties and lap shear adhesion on industrially-relevant surfaces/materials. The materials and resin temperature during AMF exposure are independently evaluated through fiber optic probes. Resin activation and propagation are characterized with TGA, DSC, and IR spectroscopy before and after magnetocuring for further elucidation of chemical crosslinking.

### Example 3B: Results—XRD Confirms the Spinel Structure and Nano Crystalline Size of CNPs

The structural determination of MnₓZn₁₋ₓFe₂O₄ CNPs are analyzed by the XRD patterns (FIG. 1A). Analysis of the diffraction pattern confirms the formation of cubic spinel structure for all the samples. The experimental peaks are matched with respective JSPDS files and hkl planes are computed with Topas software. The intense crystalline peaks observed at 20 (hkl) values of 29.9 (220), 35.08 (311), 42.6 (400), 52.9 (422), 56.3 (511), and 61.9° (440) match the experimental data for the franklinite spinel structure (JCPDS no. 10-0467), indicating the presence of MnₓZn₁₋ₓFe₂O₄ in all the samples. Small diffraction peak at 20 of 33.61° is due to a small fraction of hematite (α-Fe₂O₃) phase present in samples. Crystalline size of the particles was calculated using Scherrer formula (D=0.9λ/(β cos θ)) considering the most intense diffraction peak at 20 of 35.08° corresponds to the plane 311. An increase in the Mn content results in an increase in crystallite size of the particles. The crystalline size of Mn_{0.4}, Mn_{0.5}, Mn_{0.6} and Mn_{0.7} is found to be 9.5, 13.5, 13.7 and 13.8 nm, respectively (FIG. 1B).

### Example 3C: Results—Empirical Mn to Zn Ratio Differs by 9% to 18% from Feedstock Ratio

ICP-MS is employed to determine the Mn/Zn ratio of the four different MnₓZn₁₋ₓFe₂O₄ compositions. In FIG. 1C, the measured mol % ratios of manganese (Mn) and zinc (Zn) are presented as determined by ICP-MS and the results are compared to nominal values. ICP-MS results indicate that actual mol fraction of Mn_{0.4}, Mn_{0.5}, Mn_{0.6} and Mn_{0.7} differ from those of nominal compositions by 18%, 15%, 12% and 9%, respectively. Generally, the Zn cation gets uniformly distributed among the tetrahedral and octahedral sites. Hence, it is expected that Mn²⁺ has a higher probability to get absorbed by a nucleus than Zn²⁺. Smaller radius of Zn²⁺ (0.74 Å) than that of Mn²⁺ (0.83 Å) might be the reason for an increased absorption of Zn²⁺ into the lattice. Results also indicate that on increasing the Mn content in the particles, difference between the nominal and experimental values decreases. Incorporation of more Zn²⁺ ions is observed for the particles with lower Mn content (Mn_{0.4}).

### Example 3D: Results—Magnetization and Curie Temperature (Tc) Increases with Increasing Mn Content

The order of magnetic properties in ferrimagnetic spinels is mainly due to the super exchange interaction mechanism between the metal ions in the A and B sublattices. The substitution of non-magnetic Zn²⁺ ion, which prefers to occupy A site, reduces the exchange interaction between A and B sites. Hence, by varying the Mn/Zn ratio, the magnetic properties of the CNPs can be tuned. FIG. 1D presents the magnetization versus applied magnetic field curves measured at room temperature. The saturation magnetization (Ms) of Mn_{0.4}, Mn_{0.5}, Mn_{0.6} and Mn_{0.7} CNPs is found to be 33 emu/g, 40 emu/g, 46 emu/g and 60 emu/g, respectively. All the particles exhibit superparamagnetic behaviour with negligible hysteresis. The room temperature coercivity (He) of all the samples are represented in the inset of FIG. 1D and Table 2 below. The He decreases with increasing Mn²⁺ content, down to a value of 2.4 Oe for Mn_{0.7} particles.

TABLE 2
Magnetic characteristics of CNP (MnₓZn₁₋ₓFe₂O₄)

| | H [symbol] | Mᵣ | Mₛ | | K [symbol] | T [symbol] | T [symbol] |
|---|---|---|---|---|---|---|---|
| Sample | (Oe) | (emu/g) | (emu/g) | Mᵣ/Mₛ | (10³ J/m³) | (K) | (K) |
| Mn_{0.4} | 27.6 | 0.534 | 33 | 0.01618 | 3.2 | 84 | — |
| Mn_{0.5} | 13.4 | 0.717 | 40 | 0.01793 | 4.7 | 125 | — |
| Mn_{0.6} | 2.8 | 0.156 | 46 | 0.00339 | 8.6 | 229 | 278 |
| Mn_{0.7} | 2.4 | 0.231 | 60 | 0.00385 | 9.8 | 260 | 300 |

*denotes the effective anisotropy constant was calculated using the relation: T_{B} = KV/25 k_{B}, where T_{B} = blocking temperature, K = anisotropy constant, V = particles volume, k_{B} = Boltzmann constant. [symbol]
indicates data missing or illegible when filed

An increase of the Mn concentration in MnₓZn₁₋ₓFe₂O₄ CNPs leads to an increase in M. This increase in Ms is due to the compositional change and can also be explained by the magnetic moments of Mn²⁺ (5μ_{B}) ions being higher than those of Fe²⁺ (4μ_{B}) and Zn²⁺ (0μ_{B}) ions. For the Curie temperature measurements, the normalized temperature-dependent magnetization of CNPs under applied magnetic field of 100 Oe is recorded in the temperature range from room temperature to 400° C. (FIG. 1E). The CNP does not exhibit sharp transition at Curie temperature. Such broad distribution of Curie temperature in fine magnetic nanoparticles is often observed. In such cases, the spontaneous magnetization (M) scales as (Tc−T)^{β} with a critical exponent, β=1/3. Therefore, the M³ is plotted with respect to temperature and Tc of all CNPs is determined from M³ versus temperature graphs by extrapolation of M³ to zero. The Tc of Mn_{0.4}, Mn_{0.5}, Mn_{0.6} and Mn_{0.7} is found to be 61° C., 115° C., 138° C. and 237° C., respectively (FIG. 1E). This increase in Tc with increasing Mn % in MnₓZn₁₋ₓFe₂O₄ CNPs is due to the enhanced total magnetic interactions within the unit cell. The temperature dependence of magnetization (M-T) for Mn_{0.7}Zn_{0.3}Fe₂O₄ is also measured at different magnetic field strengths of 50 Oe, 80 Oe, 100 Oe and 140 Oe (FIG. 1F). The magnetization at room temperature increases with increasing the magnetic field strength which can be correlated to higher AMF heating of these CNPs at 140 Oe (see example 3J). The change in nature of M-T curves with changing the applied magnetic field is associated to that more thermal energy is required to randomize the magnetic spin at high applied field.

### Example 3E: Results—Low Temperature Magnetic Measurements Confirm the Superparamagnetic Nature of CNP

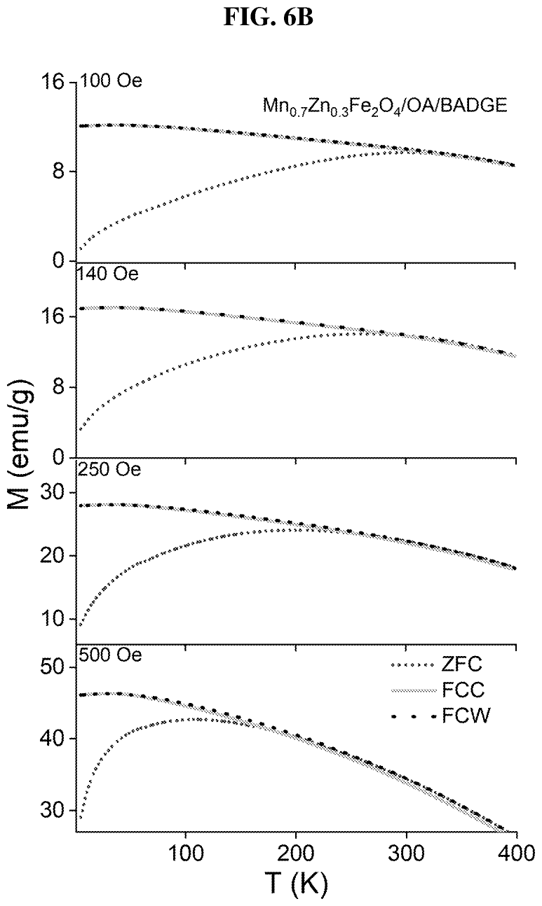

Zero field cooled (ZFC) and field cooled (FC) experiments are known to determine the blocking temperature (T_{B}) of magnetic nanoparticles. In the ZFC measurements, the CNP are cooled from 400 to 5 K in the absence of an applied magnetic field. After reaching 5 K, the magnetization is determined as a function of increasing temperature under an external magnetic field. For the FC measurements, the CNP are cooled from 400 to 5 K under an applied magnetic field of 140 Oe. Subsequently, the magnetization is recorded in two modes; with increasing temperature from 5 to 400 K which is known as field cooled warming (FCW) and with decreasing temperature from 400 to 5 K referred as field cooled cooling (FCC). FIG. 6A depicts the ZFC, FCC and FCW magnetizations of all the CNP in the temperature range of 5-400 K at an external magnetic field of 140 Oe. For all the samples, the ZFC magnetization increases with the rising temperature and exhibits a broad maximum centred at the blocking temperature (T_{B}). Such a peak temperature in the ZFC curves indicates the transition from a magnetically blocked state at low temperatures to a superparamagnetic state at higher temperatures. The T_{B} of Mn_{0.4}, Mn_{0.5}, Mn_{0.6} and Mn_{0.7} are found to 84, 125, 229 and 260 K, respectively, at magnetic field of 140 Oe, indicated by black vertical arrows in FIG. 6A. The shifting of T_{B} towards higher temperatures with increasing Mn content MnₓZn₁₋ₓFe₂O₄ is because of the strong magnetocrystalline anisotropy of Mn²⁺ ion. When CNP are cooled to 5 K without an external applied magnetic field, the net magnetic moments of CNP align along their easy axis to obtain a local minimum of potential energy. The magnetic anisotropy of nanoparticles behaves as an energy barrier to keep the magnetization direction in the easy axis. When the temperature increases from 5 K, the CNPs are thermally activated and start to align along the external magnetic field which results in an increase in magnetization with rising temperature. The magnetic anisotropy energy barrier overcome by thermal energy at blocking temperature (T_{B}), leading to a superparamagnetic state. Both FCW and FCC magnetization follow the same path and decrease with rising temperature, they merge with the ZFC magnetization at the irreversible temperature (Tᵢᵣᵣ). Tᵢᵣᵣ is related to the blocking of the larger (or agglomerated) particles. Therefore, the particle size distribution and degree of inhomogeneity can be qualitatively estimated from the Tᵢᵣᵣ−T_{B} and the Mᵣ/Mₛ. Higher values of Tᵢᵣᵣ−T_{B} and the Mᵣ/Mₛ can lead to higher inhomogeneity. The magnetic characteristics of CNP are summarized in Table 2 above. The Tᵢᵣᵣ of Mn_{0.6} and Mn_{0.7} are found to be 278 K and 300 K, respectively. FIG. 6B shows the ZFC, FCC and FCW magnetizations of coated Mn_{0.7} for a range of external magnetic fields from 100 Oe to 500 Oe, and in the temperature range of 5-400 K. At applied magnetic field of 140 Oe, the T_{B}, Tᵢᵣᵣ, and their difference (Tᵢᵣᵣ−T_{B}) of coated Mn_{0.7} CNP exhibit lower values than those of the corresponding uncoated particles, which can be associated with decreased attractive forces between the coated CNP. It can also be noticed that both T_{B} and Tᵢᵣᵣ, shift towards lower temperature with an increase in applied magnetic field, which is characteristic of superparamagnetic particles.

### Example 3F: Results—IR Spectroscopy Confirms Oleic Acid and Epoxy Surface Functionalization

The functional groups present on CNP, oleic acid, BADGE and surface modified CNP are presented in FIGS. 3A to 3C. The FTIR spectra of bare MnₓZn₁₋ₓFe₂O₄ (x=0.5, 0.6 and 0.7) CNP have a sharp peak at 560 cm⁻¹, which corresponds to the characteristic features of ferrites (Fe—O—Fe). Broad peaks at 3400 cm⁻¹ and 1642 cm⁻¹ are also observed for the stretching vibrations and H—O—H scissoring from free or absorbed hydroxide groups (FIG. 3A). FIGS. 3B and 3C depict the FTIR spectra of clean OA, BADGE, mixture of OA+BADGE and MnₓZn₁₋ₓFe₂O₄/Oleic acid/BADGE (x=0.5, 0.6 and 0.7). Peaks for the presence of OA and BADGE are observed to be very close and overlapped. The presence of oleic acid is confirmed by the two sharp peaks at 2852 cm⁻¹ and 2924 cm⁻¹ for the symmetric and asymmetric stretching vibrations of —CH₂ and —CH₃ (FIG. 3C). The peaks at 1720 cm⁻¹ and 1295 cm⁻¹ are due to the C═O and C—O stretching of the carboxylic group in oleic acid. Bending vibrations of C—H in the methylene at 2962 cm⁻¹ and 2927 cm⁻¹ with the appearance of oxirane ring peaks at 830 cm⁻¹ and 725 cm⁻¹ confirm the BADGE functionalization.

### Example 3G: Results—OA and BADGE Surface Functionalization Accounts for 20 wt. % CNP Mass

The amount of oleic acid and BADGE coated on the nanoparticles is determined by TGA. FIGS. 3D and 3E illustrate the TGA pattern of bare CNP and MnₓZn₁₋ₓFe₂O₄/Oleic acid/BADGE, BADGE, OA and mixture of OA+BADGE, respectively. A slight weight loss temperature below 150° C. in samples with and without coating could be associated with water content (FIG. 3D). Oleic acid exhibits complete weight loss at 400° C. while BADGE and mixture of OA+BADGE remains with some percentage of residue (FIG. 3E). The functionalized CNP exhibits two main weight loss stages between 150 and 500° C. and one weight loss at higher temperature (>500° C.). The first weight loss is associated with the removal of physically absorbed OA and BADGE molecules from the surface of the CNP. The second weight loss at 460° C. due to the strong binding force between CNP, OA and BADGE. The third weight loss at ˜750° C. is probably due to the complete decomposition of surfactant. The total amount of OA+BADGE coating onto the CNP is found to be 23, 21 and 16% (starting weight % at room temperature—end weight % at 800° C.) for Mn_{0.5}, Mn_{0.6} and Mn_{0.7}, respectively.

### Example 3H: Results—Colloidal Stability of Surface Modified CNP

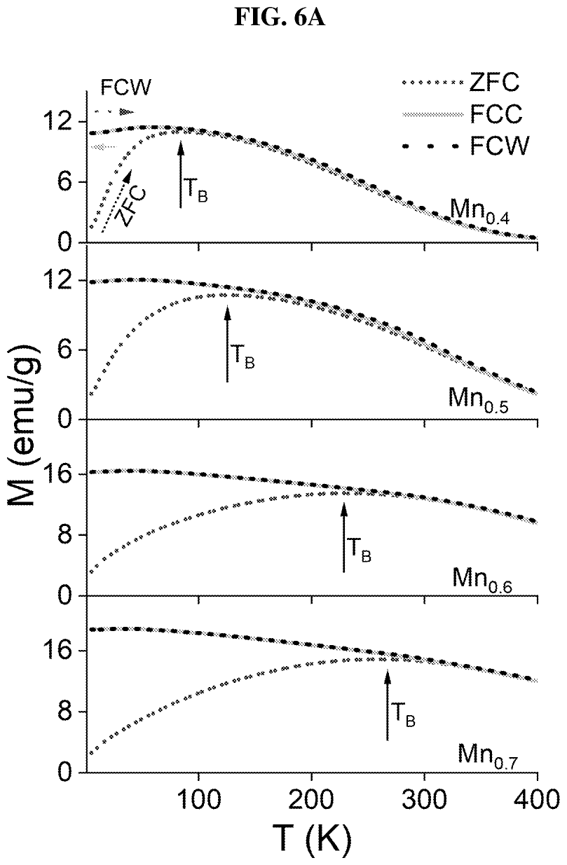

The colloidal stability of CNP is analyzed using DLS. Generally, an equilibrium between attractive forces (magnetic dipole-dipole and Vander Waals) and repulsive forces (electrostatic and steric) results in stability of nanoparticles. Hence, bare CNP are less stable due to the low electrostatic repulsive forces between them (FIG. 5). The colloidal stability of the functionalized CNP is determined by monitoring hydrodynamic size (FIG. 3F). An optimum size of 200-400 nm and count rate between ˜300 to ˜500 kcps are observed, confirming the stability of CNP in ethanol.

### Example 31: Results—Transmission Electron Micrograph Endorses the Particle Size of Surface Functionalized Mn_{0.7} from 9 to 25 nm

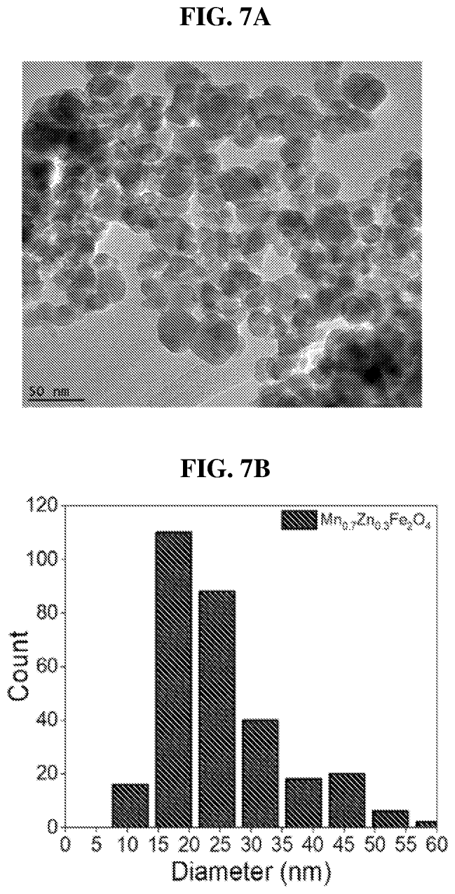

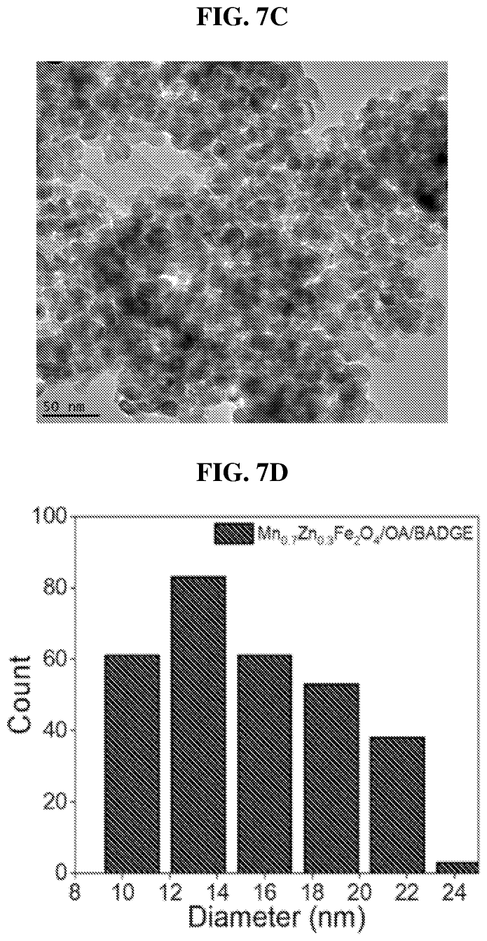

The particles size and morphology of bare and coated Mn_{0.7} particles are studied by TEM. FIGS. 7A to 7D relate to TEM micrographs of bare and coated CNP and corresponding particle size distribution histograms. The TEM images show equiaxed individual particles with some agglomeration. The particle size of bare particles is in the range of 8 to 60 nm with an average particle size of 26 nm. The observed aggregation is due to magnetic interactions between the particles and the absence of a surfactant layer. The particle size of the coated particles is in the range of 9 to 25 nm, with an average particle size of 16 nm, reasonably close to the value obtained from the XRD data (13.5 nm).

### Example 3J: Results—Controlling AMF Heating Temperature of CNP by Mn/Zn Ratio, In Situ Heating of Epoxy Resin to 160° C. within 5 Mins

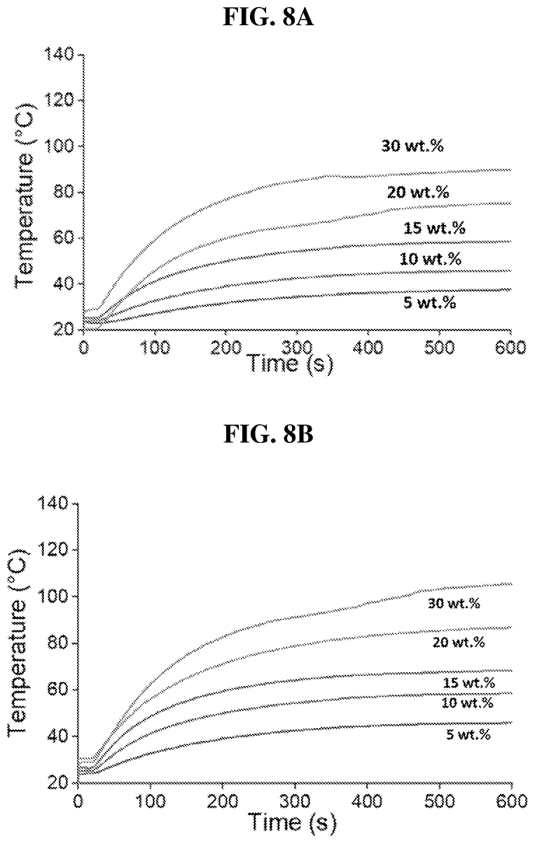

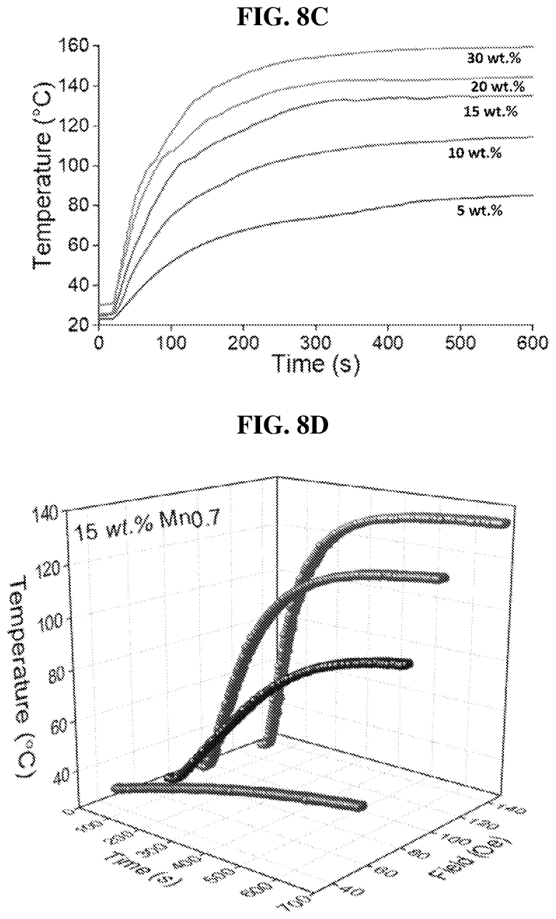

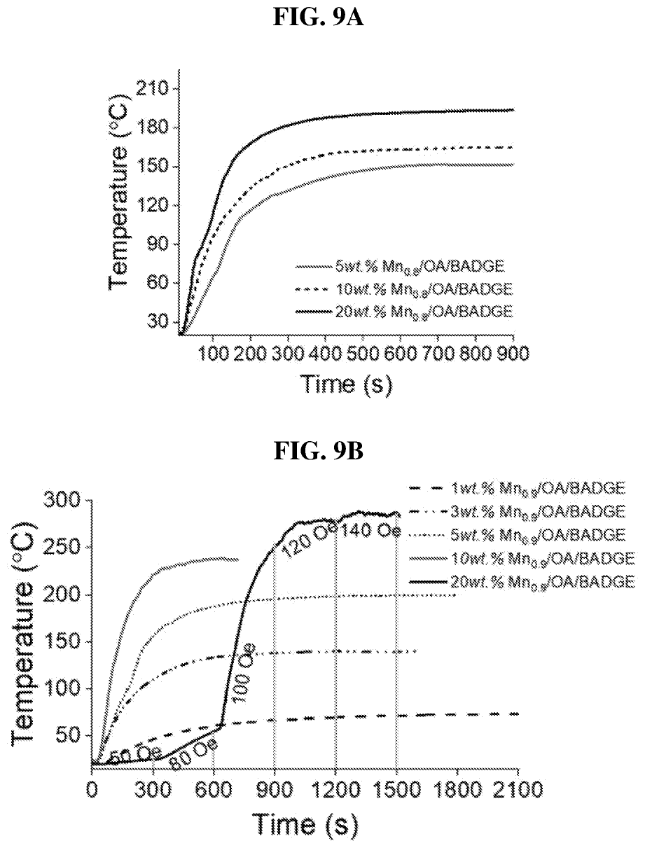

CNPs serve as AMF-to-thermal transducers to initiate thermoset adhesives. The induction coil generates the magnetic fields which interact with the nanoparticles. To check the heating efficiency, functionalized CNPs of different concentrations (5-30 wt. %) are dispersed in BADGE using ultrasonication, and the solution is then placed within the induction coil (solenoid coil) at a frequency of 400 kHz and magnetic field strength ranging from 50 Oe to 140 Oe. The heating efficiency depends strongly on alternating current (AC) magnetic field strength, Curie temperature (Tc) of nanoparticles and their content in the BADGE. The temperature required for thermoset activation can be achieved within 4-5 minutes by controlling the strength of applied magnetic field. The temperature increases until a plateau is reached ˜300 seconds. When magnetic nanoparticles suspended in an adhesive are subjected to an AC magnetic field, losses from the reversal of magnetization results in a conversion of electromagnetic energy to heat. Plateau temperature in AMF is the temperature where electromagnetic energy completely converts to heat at that particular applied magnetic field/frequency. The attained plateau temperature is a function of AC magnetic field strength and concentration of the CNPs in the adhesive. FIGS. 8A to 8D depict the temperature versus time plots obtained for the AMF heating with respect to Mn/Zn ratio, percent loading of CNPs, and field strength. The maximum temperature (Tₘₐₓ) of Mn_{0.7}Zn_{0.3}Fe₂O₄/OA/BADGE is higher than those of Mn_{0.5}Zn_{0.5}Fe₂O₄/OA/BADGE and Mn_{0.6}Zn_{0.4}Fe₂O₄/OA/BADGE at every fixed loading. In all three cases, the high loading of CNPs in BADGE results in a higher maximum temperature but importantly, only up to a maximum temperature which is controlled with the Tc of the particles. Among all, Mn_{0.7} nanoparticles exhibit the highest Tc (237° C.) and saturation magnetization (Ms) (60 emu/g). A maximum temperature of 90° C. and 105° C. is observed for Mn_{0.5} and Mn_{0.6} particles, respectively. The temperature can also be controlled by tuning the AC magnetic field, frequency and time. The frequency of the AMF system is fixed but the field strength can be varied from 0 to 140 Oe. FIG. 8D depicts the AMF heating of Mn_{0.7}Zn_{0.3}Fe₂O₄/OA/BADGE (15 wt. %) nanoparticles at field strength ranging from 50-140 Oe. The temperatures of 48° C., 90° C., 118° C. and 134° C. correlate with AC magnetic fields of 50 Oe, 80 Oe, 100 Oe and 140 Oe, respectively, reached within 10 mins. At high field strength, the plateau is achieved in less time due to the faster heat dissipation. The maximum temperatures of 140° C. and 160° C. are observed for 20 and 30 wt. % loading of Mn_{0.7} particles in BADGE at the AC field strength of 140 Oe. Similarly, the AMF heating of Mn_{0.8}Zn_{0.2}Fe₂O₄/OA/BADGE and Mn_{0.9}Zn_{0.1}Fe₂O₄/OA/BADGE nanoparticles at different concentrations (1-20 wt. %) in GDE and magnetic field strength was studied. 20 wt. % Mn_{0.9}Zn_{0.1}Fe₂O₄/OA/BADGE reaches maximum temperature of 289° C. (FIG. 9B). To prevent the scorching/hotspot formation during adhesive curing, temperature and cure time are crucial for every formulation. Herein, the AC magnetic field and time can be selected in order to achieve a particular temperature or to predict the temperature at a particular field.

### Example 3K: Results—Highest Specific Absorption Rate (SAR) of 5 Wg⁻¹ Achieved for Mn_{0.7}Zn_{0.3}Fe₂O₄/OA/BADGE at 140 Oe

The heating efficiency of the magnetic nanoparticles under AC magnetic field is defined by specific absorption rate (SAR) or specific loss power (SLP), expressed in Wg⁻¹. SAR is defined by the amount of heat generated per unit gram of magnetic materials and per unit time. It is calculated using the formula:

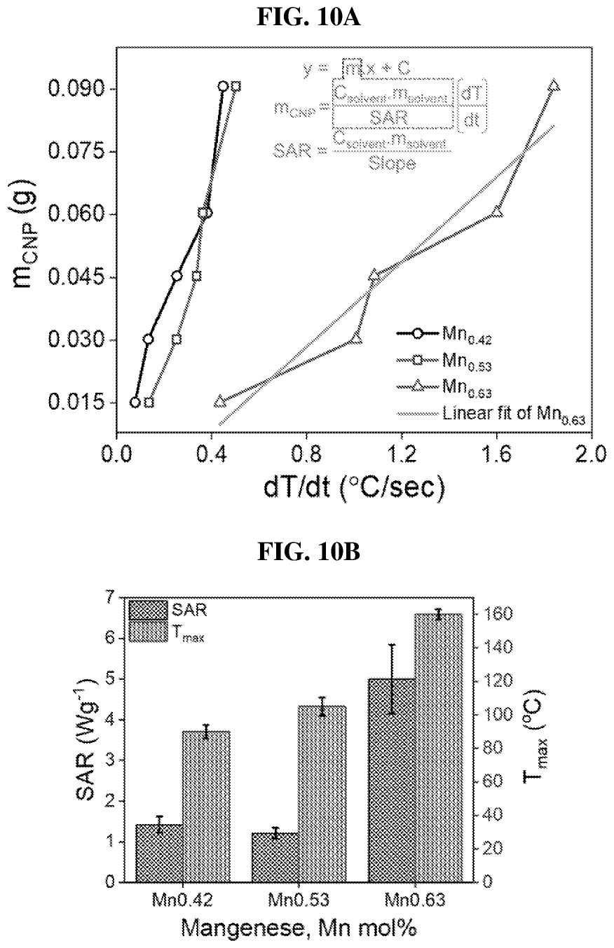

SAR=Cₛₒₗᵥₑₙₜ·mₛₒₗᵥₑₙₜ(dT/dt)/m_{CNP}

where Cₛₒₗᵥₑₙₜ is specific heat capacity of BADGE (346 J/mol K), m is the total mass of the solvent, m_{CNP} is the mass of Curie nanoparticles and dT/dt is the temperature increase per unit time, that is, the initial slope of the temperature versus time curve. The average SAR value is calculated for different loadings of surface-modified CNPs by accounting the linear fit slope. The temperature increase per unit time with mass of CNPs is represented in FIG. 10A. The SAR increases linearly with the magnetic field amplitude and the highest SAR (5 Wg⁻¹) is observed for the average loading (5-30 wt. %) of Mn_{0.7}Zn_{0.3}Fe₂O₄/OA/BADGE at 400 kHz frequency and 140 Oe amplitude because of high Ms of these CNPs. Compared to reported formulations, the SAR of Mn_{0.8}Zn_{0.2}Fe₂O₄ at a frequency of 100 kHz and amplitude of 72 Oe was as low as 0.13 Wg⁻¹. High SAR (57 Wg⁻¹ (Mn+Fe)) is also reported for Mn_{0.62}Zn_{0.41}Fe_{1.97}O₄ at high frequency of 970 kHz and field amplitude of 80 Oe. SAR ˜7.5 to 10 Wg⁻¹ of Mn—Zn ferrite is also reported at different frequency and magnetic field strength of 520 kHz and 166 Oe, respectively. It is concluded that SAR depends on several parameters, such as sample preparation method, structural and magnetic properties of the nanoparticles, amplitudes and frequency of the applied magnetic field, shape and size of nanoparticles, etc.

### Example 3L: Results—Magnetocuring Additive Cure Commercial Epoxy Adhesives

Magnetocuring of epoxy adhesives is studied with additive loading of CNPs (15, 20 and 30 wt. %) in Permabond ES558, TIM 813-HTC or BADGE-DICY composite to join different adherent materials (PMMA, ABS, glass and wood). Mn_{0.7}Zn_{0.3}Fe₂O₄/OA/BADGE particles with an average size of 14 nm provide desirable results due to their greater temperature range. The incorporation of functionalized CNPs into adhesives is done by simple hand mixing within the liquid thermoset resins. The oven cure cycle is as follows: Permabond ES558; 75 minutes at 130° C., 60 minutes at 150° C., or 40 minutes at 170° C. TIM 813HTC; 1 hr at 100° C.+1 hr at 150° C. (recommended) or 30 minutes at 150° C. (alternate). For comparison, magnetocuring experiments are performed for 1 hr at the frequency of 400 kHz and magnetic field strength of 140 Oe. Control experiments of thermal (oven) curing are performed at 160° C. for 1 hr with heating ramp rate of 10° C./min.

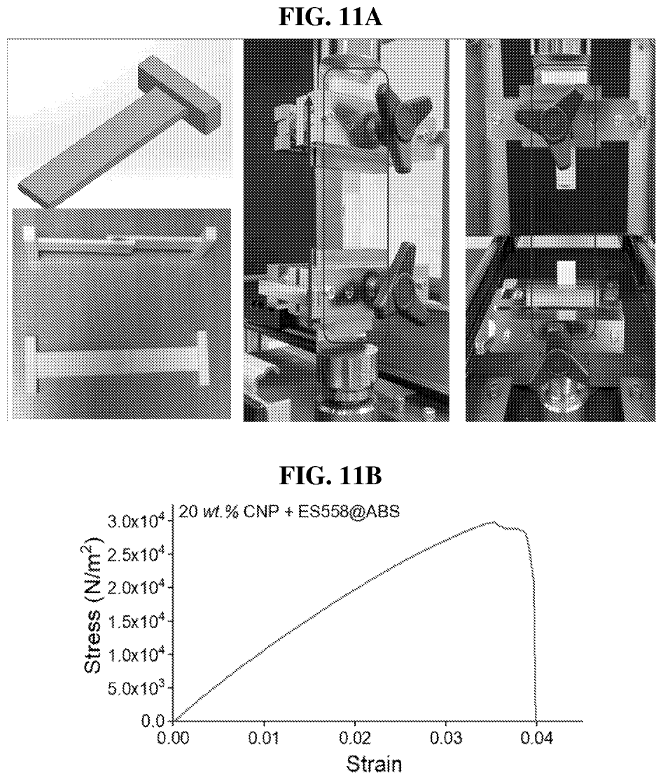

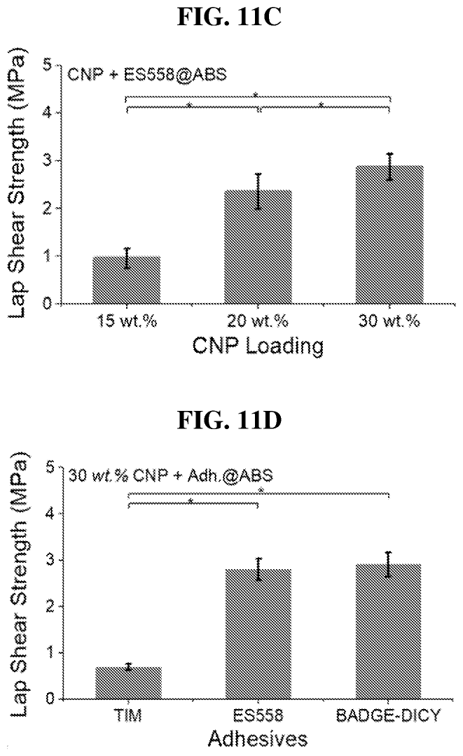

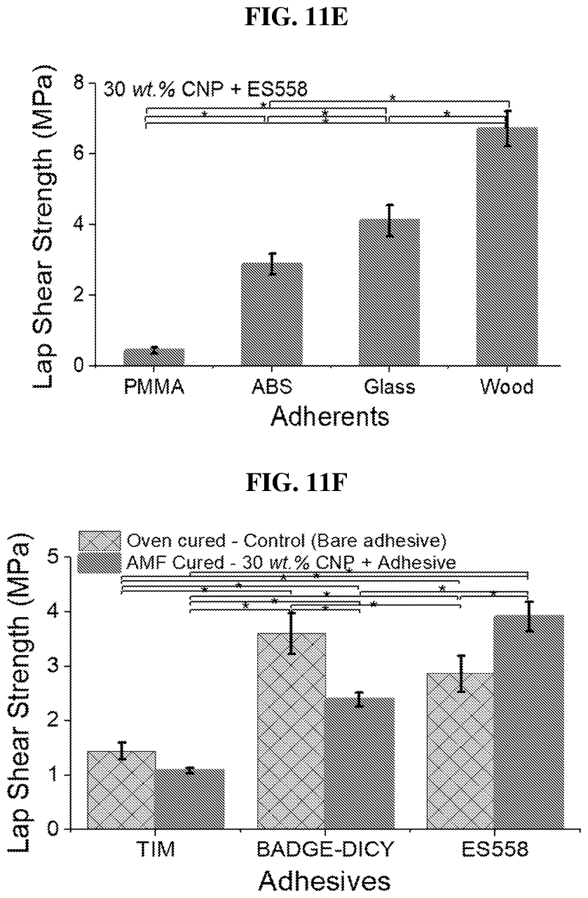

Neat adhesives (ES558, TIM 813HTC and BADGE-DICY) are applied between the ABS coupons (see FIG. 11A) and evaluated as a negative control. With no magnetic additives, there is no heating within the AMF coil. Next, epoxy/CNP magnetocuring additives samples are placed within the induction coil with a rapid increase in temperature observed. As CNPs are exposed to the AMF, heat dissipation takes place due to Neel-Brown relaxation losses.

### Example 3M: Results—Steady Lap Shear Adhesion Strength at 20-30% Loading

After AMF exposure, the samples are cooled to room temperatures and evaluated on a tensile tester under lap-shear mode with a 500 N load cell. An example profile is shown in FIG. 11B with the following formulation; 20 wt. % CNP+ES558 resin on ABS surface/material. As FIG. 11C, loading percentage can affect the final temperature, epoxy crosslinking kinetics, and ultimately lap shear adhesion. ES558 thermoset with 15 wt. % magnetocuring additives displays a lap-shear strength of 0.83 MPa, but additive concentration to 20 wt. % and above exceeds to 2 MPa, as shown in FIG. 11C. Both thermosets TIM 813HTC and BADGE-DICY (100:12) also bond ABS coupons to varying degrees (FIG. 11D).

The formulation (30 wt. % loading of CNP into ES558) is assessed against natural, plastic and glass surfaces typically found in industry (FIG. 11E). The highest lap-shear strength is achieved for wood (6.7 MPa), followed by glass (3.5 MPa), and plastics (<3 MPa), which roughly correlates to surface roughness and porosity. This does not necessarily represent the maximum adhesive bond, as the samples of plastic and wood have failure modes. Glass displays interfacial debonding at the resin/surface interface. Oven curing of ES558, TIM 813HTC and BADGE-DICY compared with magnetocured samples displays adhesion strength on the same order of magnitude, as seen in FIG. 11F.

### Example 3N: Results—Curie Nanoparticles Affords Precise Temperature Control with No Scorching

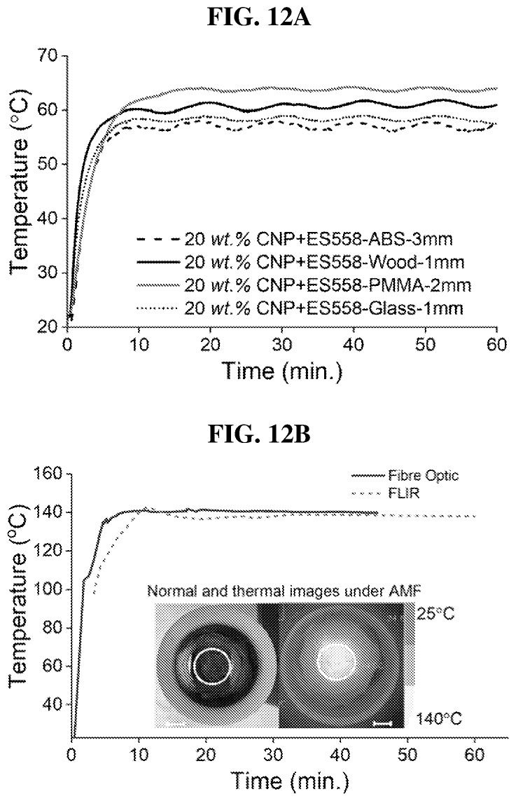

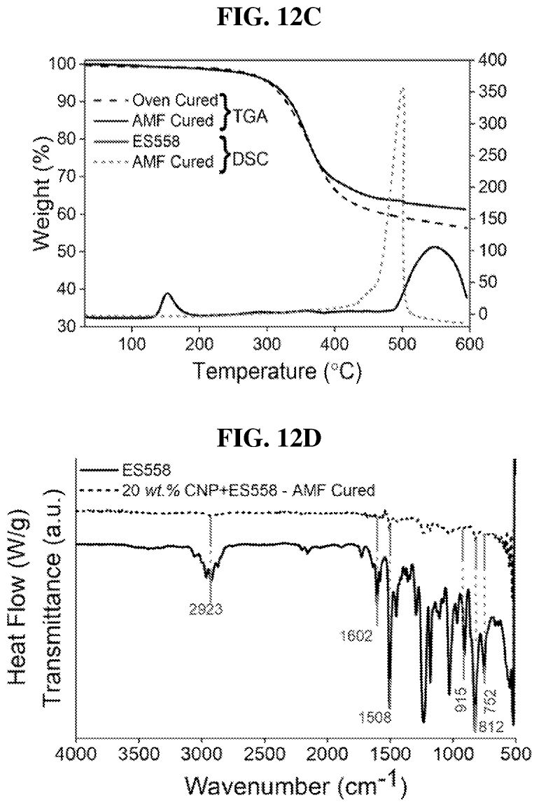

Sample surface and thermoset resin temperature is evaluated under the in situ heating provided by AMF/CNP additives. Surface temperatures are evaluated in real-time through a fibre optic thermocouple, internal thermoset resin temperature is simultaneously evaluated with a fibre optic thermocouple and infrared camera. FIG. 12A depicts the surface temperature of four different surfaces/materials during magnetocuring of ES558 with 20 wt. % loading of CNPs. Surface temperature does not exceed 60-65° C. for the 1-3 mm thick specimens, despite internal resin temperatures of 140° C. observed in FIG. 12B. No overheating is observed. Images captured by FL-IR camera during the AMF curing of 20 wt. %-loaded ES558 also confirm the local heating of thermoset resins under AMF.

Resin curing is further analysed by TGA and DSC. If incomplete curing of the resin is present, DSC displays a peak at the activation temperature. FIG. 12C displays the DSC spectra of uncured ES558 resin (positive control) and magnetocured CNP composites. A single peak for the thermoset activation temperature is observed at 150° C. for the positive control but is absent in the magnetocured composites. The overlapping TGA curves of thermocured against magnetocured samples give similar heat degradation profiles, suggesting no scorching of the magnetocured samples. A late peak after 500° C. can be seen in both clean and cured adhesive, which is due to oxidation, pyrolysis, or a combination thereof.

### Example 30: Results—IR Spectroscopy Indicates Epoxy Ring Opening and Rigid Matrix

The degree of crosslinking in ES558 is determined qualitatively with infrared (IR) spectroscopy. FIG. 12D compares uncured resin and the magnetocured CNP composites. Bending vibrations of C—H in methylene (2923 cm⁻¹) and stretching vibrations of C═C in aromatic ring (1602 and 1508 cm⁻¹) are both diminished, which is evidence of a rigid cross-linked resin. The disappearance of the peaks at 915, 812 and 752 cm⁻¹ indicates the opening of epoxy rings to form ether cross links.

### Example 4: Discussion of the Results

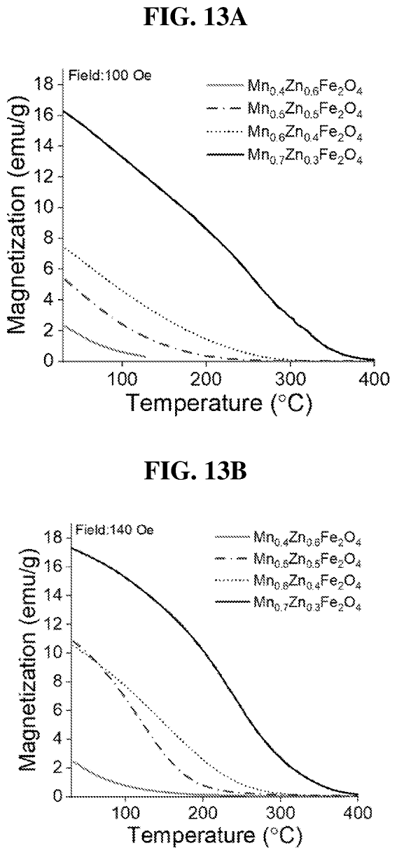

As demonstrated in the examples of the present disclosure, herein describes a platform magnetocuring technology developed to cure thermoset resins via exposure to alternating magnetic fields on non-metallic surfaces. Industrially relevant structure-activity relationships display the flexibility of the platform with respect to in situ thermal kinetics, particle loading, field strength, and commercial resins. The advanced features of the CNP-based magnetocuring technology include prevention of overheating and colloidal stability in polar organic environments. Traditional magnetocuring adhesives observed resin scorching due to runaway heating from a combination of particle size-dependent thermal kinetics and agglomeration of metal oxide particles in organic resins. However, advantageously, the CNPs of the present disclosure overcome these impediments through self-regulating magnetic absorption as the particles approach the Curie temperature, i.e. no feedback electronics are required. Failsafe temperature limits, which the present CNPs have, confer an advantage over other induction magnetic nanoparticles. This was one of the rationales for use of the present CNPs in magnetically induced heating and activation of thermoset epoxy adhesives. The aggregation of high surface energy Curie nanoparticles, chemical reactivity and dispersibility in solution were controlled by protecting the CNPs with functional shells of resin-based coatings for ease of dispersion. The coating/functionalization is performed by post-synthesis grafting of oleic acid on CNPs via covalent bonds. The oleic acid-coated particles are grafted with epoxy monomers (BADGE) to improve thermoset initiation through like-dissolves-like particle miscibility in one-component epoxy adhesives. The Fe³⁺ ions and hydroxyl groups present at the surface of particles can interact with the polar groups of oleic acid and BADGE, providing colloidal stability in epoxy. FTIR spectra and TGA analysis reveal the coating with oleic acid and BADGE on the surface of particles. However, FTIR peaks observed for the BADGE in coated particles were very small. This might be due to the interaction between oleic acid and BADGE (FIG. 3C). Long-term colloidal stability of functionalized CNPs in BADGE was observed. Particles settled down after 1-2 hrs but dispersed well again after sonication/vortex for a few minutes. Functionalized CNPs have been evaluated under AMF heating efficiency, SAR value and Hf factor. As soon as CNPs are subjected to an AC magnetic field, electromagnetic energy is converted to heat due to residual losses in MnZn ferrites. These residual losses originate from various relaxation effects of magnetization in a magnetic field. Residual losses or heat generation in small nanoparticles is due to (i) the Brownian mechanism of relaxation, in which magnetic moment is locked to the crystal axis and therefore the entire particle rotates with the magnetic field, and (ii) the Neel relaxation mechanism, in which the magnetic moment rotates within the particle in an external magnetic field. Further, the heating ability also depends on the properties of the nanomaterials, such as particle size, magnetization and magnetic anisotropy, and the strength of applied magnetic field (H) and frequency (f). Owing to the high Curie temperature and magnetization of Mn_{0.7} particles, highest heating of CNPs was observed for the Mn_{0.7}Zn_{0.3}Fe₂O₄/OA/BADGE particles. In addition to high Ms and Tc, Mn_{0.7} nanoparticles exhibit higher metastable magnetic moment than those of Mn_{0.4}, Mn_{0.5} and Mn_{0.6}, at the field used for magnetic induction, as revealed from magnetization versus temperature curves (FIGS. 13A and 13B). The SAR of these functionalized CNPs dispersed in BADGE was found to be 5 Wg⁻¹. The variation in SAR with changing the mol % of Mn in MnₓZn₁₋ₓFe₂O₄ might be due to the different associated Ms and therefore, a notable change in the dipolar interparticle interactions. Further, the product of the frequency and the magnetic field amplitude (H×f) can determine whether the field/frequency is in the safe zone for medical application. The Brezovich criterion sets a safety threshold to use the AC magnetic field for human exposure by limiting the product of frequency and amplitude to 5×10⁸ Am⁻¹ s⁻¹. The use of high-frequency and high-amplitude AMF produces eddy currents in conducting media which can result in nonspecific heating or damage to the human body. Considerably, Hf factor may not be more than 5×10⁹ Am⁻¹ s⁻¹ for medical applications, given that smaller field exposure may be better tolerated by patients. The maximum Hf for the present systems is 4.4×10⁹ Am⁻¹ s⁻¹, which suggests that curing using the present approach can be applied for medical translation.

AMF heating of CNPs allows the crosslinking of one-component epoxy adhesives through in situ heating. The complete curing of ES558 magnetoadhesive was achieved by applying magnetic field strength of 140 Oe for 1 hr at a fixed frequency of 400 kHz. The structure-activity relationships were studied for different loadings of CNPs, adhesive composites, adherents and controlled with oven-curing. The increase in the loading of CNPs increases the shear strength up to 3 MPa for ABS. It was assumed that the addition of CNPs increased the stiffness of adhesives. The increased shear strength observed is probably due to the interactions between the Curie nanoparticles and one-component epoxy adhesives. The interaction was facilitated by the presence of the epoxy (BADGE) coating on the surface of Curie nanoparticle. Hence, this results in greater force transfer between the Curie nanoparticles and matrix resulting in increased strength. In the case of different adherents, the strongest adhesion was observed for wood, with shear strength of 6.69 MPa, which can be associated with available pores on the wood surface. Magnetoadhesive can easily penetrate into the porous structure of wood during magnetocuring process, which results in high lap shear strength. The small difference in surface temperature of different adherents was due to their different thickness and thermal conductivity. The maximum surface temperature was less than 65° C. irrespective of the type of adherent, which suggests that magnetocuring was locally heating up the joining part while preventing scorching. These results reveal self-controlled heating of magnetoadhesive which has potential applications in polymer industries where higher temperature above a certain limit may destroy the object. The present CNPs are advantageous for development of several magnetoadhesives using commercial adhesives, which already has a proof of concept to join a range of materials using magnetoadhesive under AMF, whereas these materials are traditionally almost, if not impossible, to join using conventional oven method. The present CNPs offers an approach of curing that includes being remotely controlled with rapid and localized heating, at the same time reducing cost and energy, and therefore desirably suitable for a range of industries.

The presently described oleic acid- and epoxy-functionalized CNPs are usable for the magnetocuring of one-component epoxy adhesives, but the present CNPs can also be further functionalized or decorated with various functional materials as per applications' requirement. The present AMF heating results illustrate that the magnetic field (140 Oe) and frequency (400 kHz) provides for heating of CNPs to below the Curie temperature. Increase in the magnetic field strength may lead to an increase in the AMF heating up to the Curie temperature control point.

### Example 5A: Further Examples—Magnetocuring Additives Cure Bioadhesive, CaproGlu

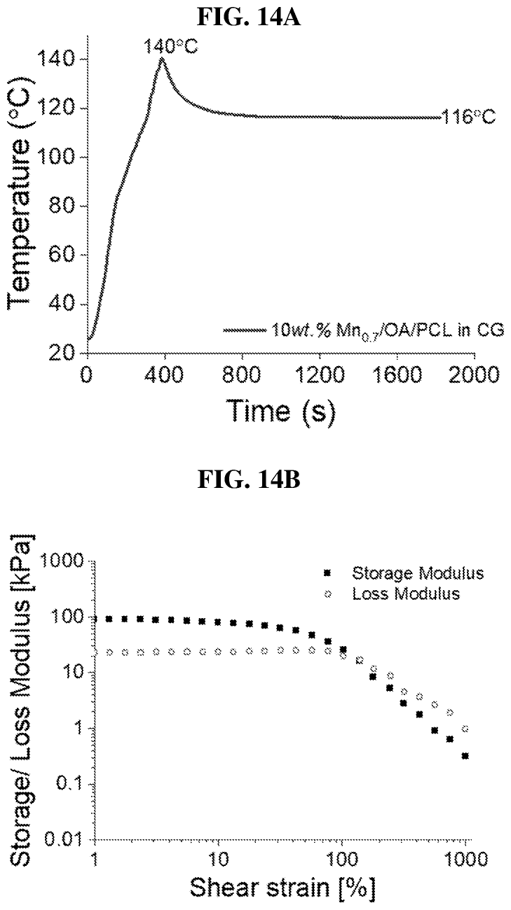

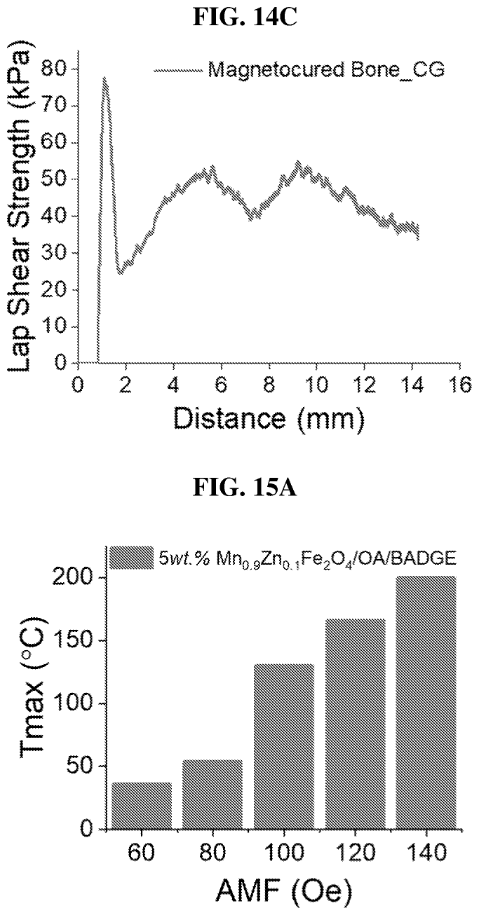

In a further example, magnetocuring of CaproGlu is studied with additive loading of CNP, 10 wt. % Mn_{0.7}Zn_{0.3}Fe₂O₄/OA/PCL and 50 wt. % Mn_{0.7}Zn_{0.3}Fe₂O₄/OA/BADGE. The incorporation of CNP into CaproGlu is done by simple hand mixing and this matrix is filled into glass vial (1.5 mL) and animal bone (3 mm, diameter). Magnetocuring experiments are performed at 140 Oe magnetic field strength and 400 kHz frequency for 30 mins. The temperature profile for the CaproGlu curing with 10 wt. % Mn_{0.7}Zn_{0.3}Fe₂O₄/OA/PCL in glass vial is represented in FIG. 14A. After AMF exposure, the samples are cooled to room temperatures and storage/loss modulus of cured sample is performed by rheometer at 5N of force (FIG. 14B). The adhesion strength of bone sample is evaluated on a tensile tester under lap-shear mode with 100N load cell. FIG. 14C represents the adhesion strength of 77 kPa for magnetocured bone sample with 50 wt. % loading of Mn_{0.7}Zn_{0.3}Fe₂O₄/OA/BADGE.

### Example 5B: Further Examples—Controlling AMF Heating Temperature of CNP by Carbon Nanotubes (CNTs)

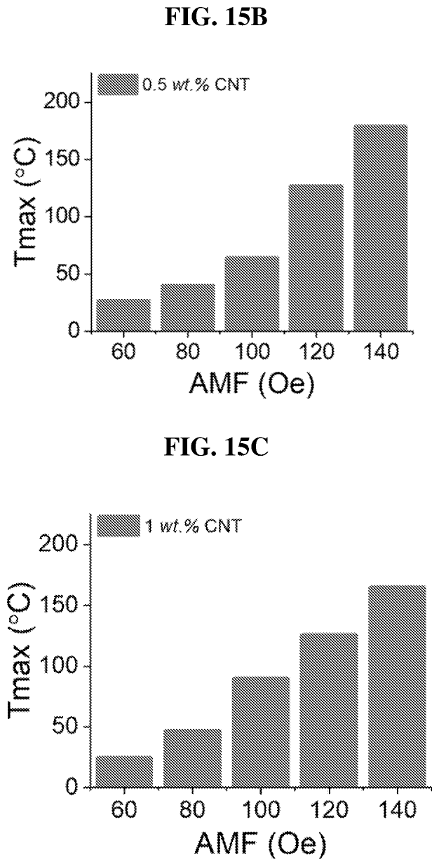

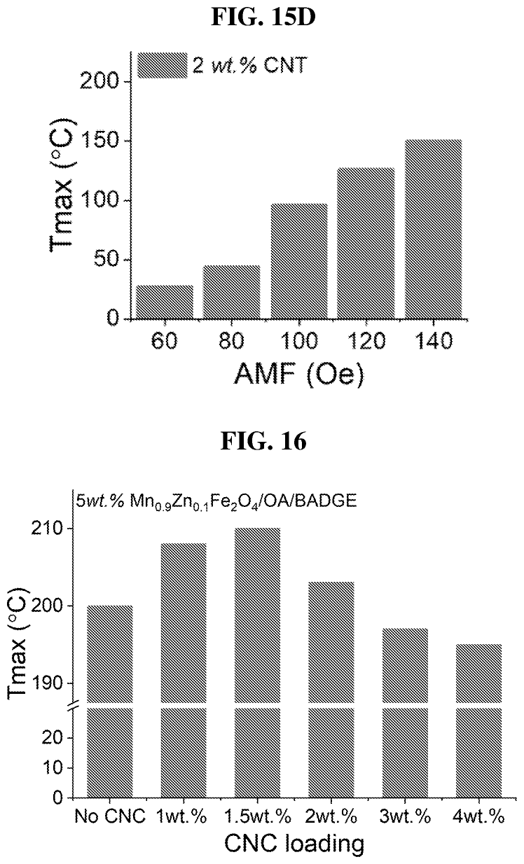

Incorporation of 2 wt. % CNTs mixed with dispersed CNPs shrinks AMF heating by 50° C. To check the heating efficiency, 5 wt. % of Mn_{0.9}Zn_{0.1}Fe₂O₄/OA/BADGE CNPs are dispersed in glycerol diglycidyl ether (GDE) using ultrasonication, followed by the physical incorporation of 0.5 wt. % to 2 wt. % of CNTs (COOH functionalized), and sonicated again to achieve good dispersion. This solution is then placed within the induction coil at a frequency of 400 kHz and magnetic field strength ranging from 140 Oe to 60 Oe. FIGS. 15A to 15D depict the temperature versus magnetic field strength plots obtained for the AMF heating with respect to percent loading of CNTs. The maximum attained temperature for Mn_{0.9}Zn_{0.1}Fe₂O₄/OA/BADGE nanoparticles without and with 0.5, 1 and 2 wt. % CNTs is 200, 179, 165 and 150° C., respectively. The tuning of AMF heating is established with the incorporation of CNTs and it is demonstrated that temperature increases until a plateau is reached around 1000 seconds. This attained plateau temperature is a function of AC magnetic field strength and concentration of CNTs in the composite. Noteworthy, an increase in the loading of CNTs into a mixture of 5 wt. % Mn_{0.9}Zn_{0.1}Fe₂O₄/OA/BADGE and GDE, results in the decrease in the maximum temperature at each magnetic field strength, respectively.

### Example 5C: Further Examples—Controlling AMF Heating Temperature of CNP by Carbon Nanocoils (CNCs)

Carbon nanocoils, CNCs (1.5 wt. %) boosts the AMF heating of CNPs by 10° C. CNCs' influence on the AMF heating of 5 wt. % of Mn_{0.9}Zn_{0.1}Fe₂O₄/OA/BADGE in GDE was evaluated. Samples were prepared by first dispersing 5 wt. % of Mn_{0.9}Zn_{0.1}Fe₂O₄/OA/BADGE particles into glycerol diglycidyl ether (GDE) followed by physically adding the CNC into the matrix. Prior to experiment, all the samples were sonicated for 1 hr. FIG. 16 shows the temperature versus CNC loading curves obtained from AMF heating at frequency of 400 kHz and magnetic field strength of 140 Oe. Incorporation of 1-1.5 wt. % of CNC s leads to the increase in the AMF heating of CNPs by ˜10° C. while the higher loading of CNCs (2, 3 and 4 wt. %) is observed to shield the magnetic heating of CNPs. Shielding of CNP heating under magnetic field by 4 wt. % CNCs accounts for the decrease in the AMF heating of about 6° C.

### Example 5D: Further Examples—Bare CNT and CNC are Absent of any Heating Under AMF at 140 Oe

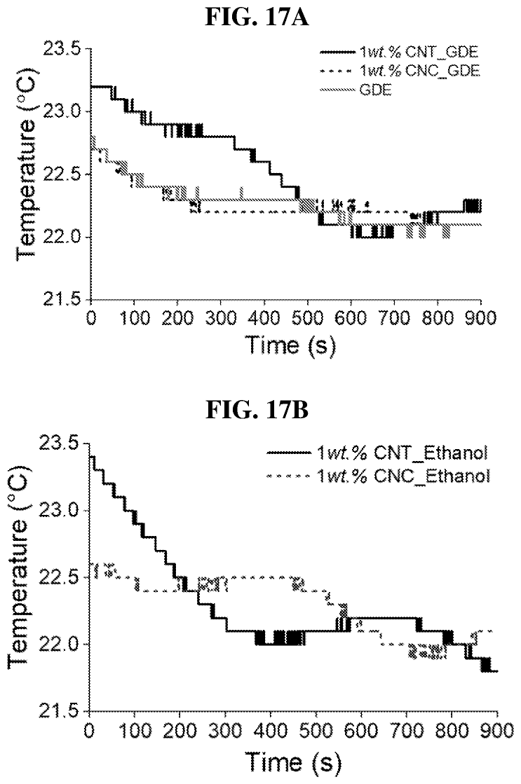

1 wt. % COOH functionalized carbon nanotubes (CNTs) and carbon nanocoils (CNCs) were dispersed in glycerol diglycidyl ether (GDE) and ethanol (FIGS. 17A and 17B). All the samples were sonicated for 1 hr and vortexed for 1-2 mins prior to being kept under AMF at 140 Oe. All the controls, 1 wt. % CNC and CNT in GDE (FIG. 17A) and ethanol (FIG. 17B) do not show any heating under alternating magnetic field.

### Example 6A: Further Examples—Increase Shelf Life with No Use of Hardener

Examples 6A to 6C demonstrate for hardener-free BADGE based magnetoadhesive to increase the shelf life of adhesive. The present BADGE-based hardener-free magnetoadhesive improves the shelf life of adhesive. Magnetocuring additives, CNP have been directly incorporated into resin and cured the ABS coupons (100% infill) under AMF. Traditionally, in the presence of a hardener in the adhesive, activation of the resin/adhesive may occur over a period of time (˜4-6 months), which undesirably decreases the shelf life of adhesive composite. However, the present approach offers a more stable formulation of magnetoadhesive as it circumvents the use of hardener. The present BADGE-based magnetoadhesive may include the following steps.

Charging CNP and BADGE in a ratio between 5 to 30 wt. %. Bonding the ABS coupons within 10 min with no scorching. Advantageously, the resultant adhesion strength surpasses the strength of ABS coupons for 30 wt. % CNP loading (5.2 MPa). The examples below describe for the present BADGE-based magnetoadhesive in more details.

### Example 6B: Further Examples—Hardener-Free Magnetoadhesive Bond ABS with No Scorching

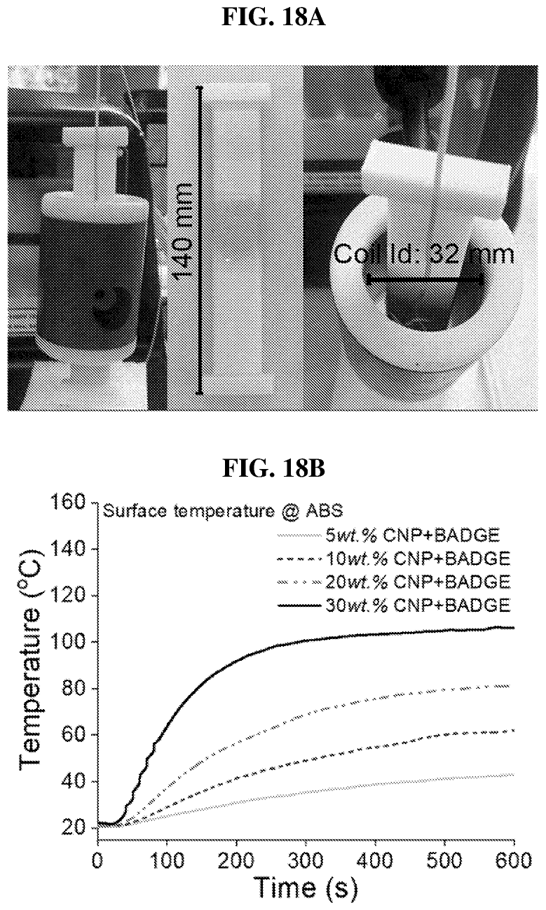

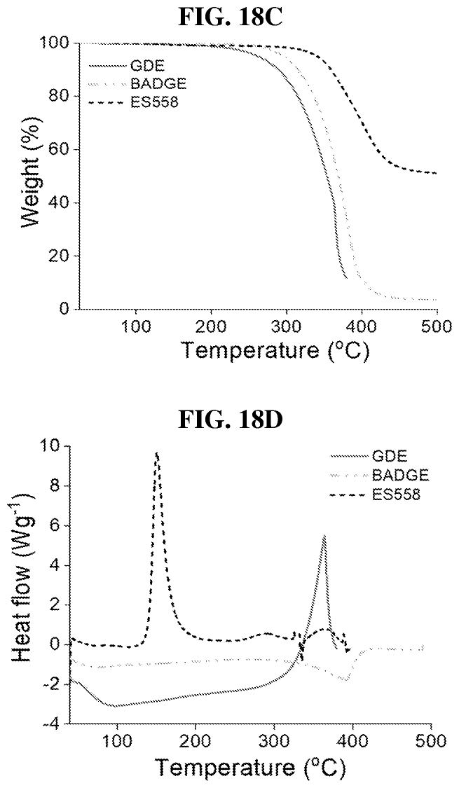

In order to develop a hardener-free magnetoadhesive, 5-30 wt. % of CNP are directly mixed with epoxy resin (bisphenol A diglycidyl ether, BADGE) with no hardener. Magnetoadhesive (CNP+BADGE) is applied on the surface area of 1 cm² and prepared with a sandwich structure of ABS coupons. Fiber optic sensor is placed on the ABS coupon surface to monitor the surface temperature (FIGS. 18A and 18B). Prior to magnetocuring, the thermal stability and activation temperature of BADGE is monitor using TGA-DSC (FIGS. 18C and 18D). In case of epoxy resins (without hardener), no sharp transition for the activation temperature is observed below 300° C. in DSC profile. However, for the epoxy adhesive with hardener (Permabond ES558), there is a sharp activation peak at 150° C. Subsequently, ABS coupons are bonded under AMF and surface temperature during magnetocuring is recorded (FIG. 18B). Hardener-free magnetoadhesive applied ABS coupons with 10-30 wt. % loading of CNP in epoxy (BADGE) are observed to be cured within 600 seconds of AMF exposure, while limiting the surface temperature ˜100° C. for 30 wt. % CNP (FIG. 18B).

### Example 6C: Further Examples—Magnetocuring Additive Cured BADGE-Based Magnetoadhesive without Hardener

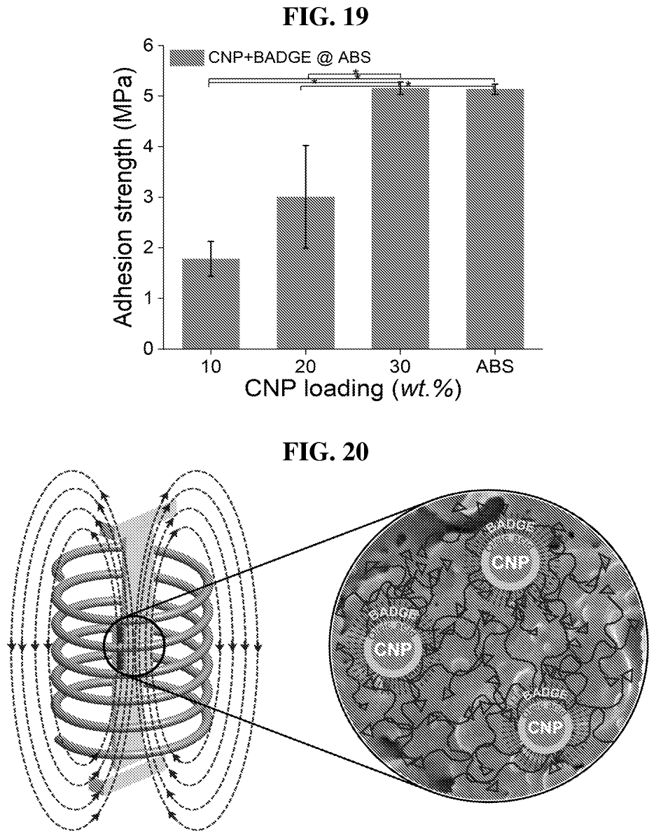

BADGE/CNP samples described above are stressed until destruction to determine failure method and ultimate adhesion strength. The lap shear test employs 3D printed ABS coupons with no surface cleaning, using 2.5 kN load cell. Adhesion strength of neat BADGE+CNP are represented in FIG. 19. CNP loading into epoxy (BADGE) without the addition of hardener is evaluated under three wt. % ratios (FIG. 19). Adhesion strength correlates with CNP loading, from 1.9 MPa (10 wt. % CNP) to 3.1 MPa (20 wt. % CNP) to 5.2 MPa (30 wt. % CNP). Material failure is observed for 30 wt. % CNP+BADGE sample, while others displays cohesive or adhesive failure. As a control, tensile strength of ABS coupons observes a tensile strength similar to 30 wt. % CNP samples at ˜5.2 MPa (FIG. 19).

### Example 7: Summary, and Commercial and Potential Applications

The present disclosure relates to one-pot composites with colloidal stability that confers non-contact ‘magnetocuring’ through exposure to alternating magnetic fields.

The present disclosure may include a composite that includes a thermosetting polymer, magnetic nanoparticles which possess a Curie temperature dispersed in the thermosetting polymer, wherein the magnetic nanoparticles have a surfactant layer chemically bonded to the magnetic nanoparticles, and a layer of monomers is grafted on the surfactant layer.

The thermosetting polymer may be selected from the group consisting of bisphenol A diglycidyl ether (BADGE), Permabond ES558, TIM-813HTC, BADGE-dicyandiamide, and mixtures thereof. The thermosetting polymer can be cured when placed in an alternating magnetic field. The alternating magnetic field can have a field strength of 50-140 Oe and/or a frequency of 100 kHz to 1 MHz. The thermosetting polymer can be placed in the alternating magnetic field from 5 minutes to 60 minutes.

The magnetic nanoparticles may have a composition represented by a formula of MnₓZn₁₋ₓFe₂O₄, NiₓZn₁₋ₓFe₂O₄, and/or CoₓZn₁₋ₓFe₂O₄, wherein 0.4≤x≤0.9. The surfactant layer may include a fatty acid having 15 to 20 carbons (e.g. oleic acid). The layer of monomers may include epoxy-based molecules (e.g. bisphenol A diglycidyl ether, glycerol diglycidyl ether) and/or polycaprolactone-based molecules.

The composite may further include carbon allotropes (e.g. carbon nanotubes (CNT) and/or carbon nanocoils (CNC)).

In the present disclosure, a series of Curie nanoparticles, for example having the compositional formula of MnₓZn₁₋ₓFe₂O₄, were developed with a Curie temperature ranging from 80-239° C. The oleic acid/BADGE functionalized CNPs dispersed well in BADGE and provide long-term colloidal stability in epoxy and one-component epoxy adhesives. 20-30 wt. % loading of Mn_{0.7}Zn_{0.3}Fe₂O₄/OA/BADGE into ES558 was found to be suitable for magnetocuring of one-component epoxy adhesives that has no scorching. Mechanical testing results indicate a lap shear strength up to 6.69 MPa for wood samples. The one-component magnetocuring adhesive allows development or modification of the existing formulations with CNPs as filler/modifier added into it. The present composites are potentially usable in various applications, such as in the fields of sports, automotive and aerospace.

The present disclosures relates to modifier methodology involving the present CNPs. The method allows CNPs incorporation into readily available thermoset adhesive formulations, e.g. laboratory synthesized BADGE-DICY and bioadhesive CaproGlu. The present magnetocuring offers a more cost-effective activation method, as the adhesive is heated directly without thermal conduction through the surface/material which the adhesive is applied thereon. Herein, curing of different adhesives through AMF activation or ‘magnetocuring’ is demonstrated on wood, ceramics, plastics and animal bone, which is of significant interest in the medical, sports, automotive, and aerospace industries. The advancement brought about by the present adhesive technology is an economical boost across a wide range of sectors.

While the present disclosure has been particularly shown and described with reference to specific embodiments, it should be understood by those skilled in the art that various changes in form and detail may be made therein without departing from the spirit and scope of the present disclosure as defined by the appended claims. The scope of the present disclosure is thus indicated by the appended claims and all changes which come within the meaning and range of equivalency of the claims are therefore intended to be embraced.

1. An adhesive additive for magnetically curing an adhesive, the adhesive additive comprising:
a magnetic nanoparticle comprising
(i) a metal, wherein the metal comprises iron, manganese, cobalt, nickel, and/or zinc, or
(ii) a metal oxide, wherein the metal oxide contains a metal which comprises iron, manganese, cobalt, nickel, and/or zinc;
a coating on the magnetic nanoparticle, wherein the coating comprises
(a) a surfactant or an inorganic material; and
(b) a monomer or a polymer which is miscible with an adhesive substrate which the adhesive additive is incorporable to,
wherein the magnetic nanoparticle produces thermal energy in response to an alternating magnetic field applied thereto for the adhesive substrate to form cross-linkages.

2. The adhesive additive of claim 1,
wherein the magnetic nanoparticle is represented by a formula of AₓZn₁₋ₓFe₂O₄;
wherein A is cobalt, manganese, or nickel; and
x has a value in the range of 0.4 to 0.99.

3. The adhesive additive of claim 1, wherein the surfactant is formed as an organic coating, wherein the organic coating comprises a fatty acid having 15 to 20 carbon atoms.

4. (canceled)

5. (canceled)

6. The adhesive additive of claim 1, wherein the inorganic material comprises silica, alumina, carbon, or glass.

7. The adhesive additive of claim 1, wherein the monomer comprises an epoxy.

8. (canceled)

9. The adhesive additive of claim 7, wherein the monomer further comprises a hardener, wherein the hardener comprises a dicyandiamide.

10. The adhesive additive of claim 1, wherein the polymer comprises polycaprolactone.

11. The adhesive additive of claim 1, further comprising a carbon allotrope.

12. (canceled)

13. An adhesive which is magnetically curable, the adhesive comprising:
the adhesive additive of claim 1; and
an adhesive substrate.

14. The adhesive of claim 13, wherein the adhesive substrate is:
(i) a resin comprising a thermoset which is activated to form cross-linkages by the thermal energy produced from a magnetic nanoparticle in the adhesive additive of claim 1, wherein the thermoset comprises epoxy and diazirine; or
(ii) a resin comprising a thermoplastic, wherein the thermoplastic comprises polycaprolactone.

15. (canceled)

16. (canceled)

17. A method of forming the adhesive additive of claim 1, the method comprising:
providing a magnetic nanoparticle comprising
(i) a metal, wherein the metal comprises iron, manganese, cobalt, nickel, and/or zinc, or
(ii) a metal oxide, wherein the metal oxide contains a metal which comprises iron, manganese, cobalt, nickel, and/or zinc;
mixing an aqueous solution comprising the magnetic nanoparticle with a surfactant; and
mixing an organic solution comprising the magnetic nanoparticle coated with the surfactant with (i) a monomer or (ii) a polymer which is miscible with an adhesive substrate which the adhesive additive is incorporable to.

18. The method of claim 17, wherein providing the magnetic nanoparticle comprises:
mixing an alkaline solution with two precursor solutions to form an alkaline mixture, wherein the alkaline solution contains a first metal precursor, wherein each of the two precursor solutions contains a second metal precursor and a third metal precursor, respectively, wherein the first metal precursor, the second metal precursor, and the third metal precursor form different metals in the magnetic nanoparticle; and
hydrothermally treating the alkaline mixture to form the magnetic nanoparticle.

19. (canceled)

20. (canceled)

21. The method of claim 17, wherein mixing the organic solution comprising the magnetic nanoparticle coated with the surfactant with (i) the monomer or (ii) the polymer comprises:
dispersing the magnetic nanoparticle coated with the surfactant in an organic medium;
dissolving the monomer or the polymer in an organic solvent to form a monomer solution or a polymer solution, respectively; and
mixing the monomer solution or the polymer solution with the organic medium containing the magnetic nanoparticle coated with the surfactant.

22. The method of claim 17, further comprising:
adding the adhesive additive in a further resin; and
mixing a carbon allotrope with the further resin containing the adhesive additive.

23. A method of forming the adhesive additive of claim 1, the method comprising:
providing a magnetic nanoparticle comprising
(i) a metal, wherein the metal comprises iron, manganese, cobalt, nickel, and/or zinc, or
(ii) a metal oxide, wherein the metal oxide contains a metal which comprises iron, manganese, cobalt, nickel, and/or zinc;
forming one or more surfactants on the magnetic nanoparticle;
forming an inorganic precursor on the one or more surfactants;
calcinating the magnetic nanoparticle with the inorganic precursor to remove the one or more surfactants and to form an inorganic material coated on the magnetic nanoparticle; and
mixing an organic mixture comprising the magnetic nanoparticle coated with the inorganic material with (i) a monomer or (ii) a polymer which is miscible with an adhesive substrate which the adhesive additive is incorporable to.

24. The method of claim 23, wherein providing the magnetic nanoparticle comprises:
mixing an alkaline solution with two precursor solutions to form an alkaline mixture, wherein the alkaline solution contains a first metal precursor, wherein each of the two precursor solutions contains a second metal precursor and a third metal precursor, respectively, wherein the first metal precursor, the second metal precursor, and the third metal precursor form different metals in the magnetic nanoparticle; and
hydrothermally treating the alkaline mixture to form the magnetic nanoparticle.

25. The method of claim 23 or 21, wherein the one or more surfactants comprise oleic acid, hexadecyltrimethylammonium bromide, and/or 1-butanol.

26. (canceled)

27. The method of claim 23, wherein the inorganic precursor comprises tetraethyl orthosilicate, aluminum isopropoxide, aluminum hydroxide, alumina, starch, glucose, activated carbon, fused silica, bioglass or calcium sodium phosphosilicate.

28. (canceled)

29. The method of claim 23, wherein mixing the organic mixture comprising the magnetic nanoparticle coated with the inorganic material with (i) the monomer or (ii) the polymer comprises:
dispersing the magnetic nanoparticle coated with the inorganic material in an organic medium;
dissolving the monomer or the polymer in an organic solvent to form a monomer solution or a polymer solution, respectively;
mixing the monomer solution or the polymer solution with the organic medium containing the magnetic nanoparticle coated with the inorganic material.

30. The method of claim 23, further comprising:
adding the adhesive additive in a further resin; and
mixing a carbon allotrope with the further resin containing the adhesive additive.
